(19) United States
(12) Patent Application Publication
(10) Pub. No.: US 2025/0133601 A1
(43) Pub. Date: Apr. 24, 2025

(54) METHOD OF TRANSMISSION WITH REPETITION, TERMINAL DEVICE AND NETWORK DEVICE

(71) Applicant: GUANGDONG OPPO MOBILE TELECOMMUNICATIONS CORP., LTD., Dongguan (CN)

(72) Inventor: Nande ZHAO, Dongguan (CN)

(21) Appl. No.: 19/001,191

(22) Filed: Dec. 24, 2024

Related U.S. Application Data
(63) Continuation of application No. PCT/CN2022/113160, filed on Aug. 17, 2022.

(51) Int. Cl. H04W 74/0833; H04L 1/00; H04W 72/1273; H04W 72/231

(52) U.S. Cl. CPC H04W 74/0833; H04L 1/0061; H04W 72/1273; H04W 72/231

(57) ABSTRACT

Embodiments of this application provides a method of transmission with repetition, a terminal device and a network device. The method of transmission with repetition includes: receiving, by a terminal device, a repetition of a message transmission in a random access procedure. In embodiments of this application, a repetition of a message transmission in a random access procedure can improve a success rate of random access.

This application is a continuation of International Application No. PCT/CN2022/113160, filed on Aug. 17, 2022, the disclosure of which is hereby incorporated by reference in its entirety.

### TECHNICAL FIELD

This application relates to the field of communications, and more specifically, to a method of transmission with repetition, a terminal device, and a network device.

### BACKGROUND

A random access procedure may include a process from a time at which a terminal device sends a random access preamble to attempt to access a network to a time at which a basic signaling connection to the network is established. The random access procedure involves a plurality of types of messages, such as a physical random access channel (PRACH), a random access response (RAR) message, a physical uplink shared channel (PUSCH), and a physical downlink shared channel (PDSCH). The current random access procedures do not support repetited transmission of some messages.

### SUMMARY

An embodiment of this application provides a method of transmission with repetition, including:
receiving, by a terminal device, a repetition of a message transmission in a random access procedure.

An embodiment of this application provides a method of transmission with repetition, including:
performing, by a network device, a repetition of a message transmission in a random access procedure.

An embodiment of this application provides a terminal device, including:
a first processing unit, configured to receive a repetition of a message transmission in a random access procedure.

An embodiment of this application provides a network device, including:
a processing unit, configured to perform a repetition of a message transmission in a random access procedure.

An embodiment of this application provides a terminal device, including a processor and a memory. The memory is configured to store a computer program, and the processor is configured to invoke and run the computer program stored in the memory to cause the terminal device to perform the method of transmission with repetition described above.

An embodiment of this application provides a network device, including a processor and a memory. The memory is configured to store a computer program, and the processor is configured to invoke and run the computer program stored in the memory to cause the network device to perform the method of transmission with repetition described above.

An embodiment of this application provides a chip, configured to implement the method of transmission with repetition described above.

Specifically, the chip includes: a processor, configured to invoke and run a computer program from a memory to cause a device installed with the chip to perform the method of transmission with repetition described above.

An embodiment of this application provides a computer-readable storage medium, configured to store a computer program. When the computer program is run by a device, the device is enabled to perform the method of transmission with repetition described above.

An embodiment of this application provides a computer program product, including computer program instructions. The computer program instructions enable a computer to perform the method of transmission with repetition described above.

An embodiment of this application provides a computer program. When the computer program is run on a computer, the computer is enabled to perform the method of transmission with repetition described above.

### BRIEF DESCRIPTION OF DRAWINGS

FIG. 1 is a schematic diagram of an application scenario according to an embodiment of this application.

FIG. 2 is a schematic diagram of a communication model of an NTN system according to an embodiment of this application.

FIG. 3 is a schematic diagram of startup timing of an RAR window in an NTN system according to an embodiment of this application.

FIG. 4 is a schematic flowchart of a method of transmission with repetition according to an embodiment of this application.

FIG. 5 is a schematic flowchart of a method of transmission with repetition according to an embodiment of this application.

FIG. 6 is a schematic flowchart of a method of transmission with repetition according to an embodiment of this application.

FIG. 7 is a schematic flowchart of a method of transmission with repetition according to an embodiment of this application.

FIG. 8 is a schematic flowchart of a method of transmission with repetition according to an embodiment of this application.

FIG. 9 is a schematic flowchart of a method of transmission with repetition according to an embodiment of this application.

FIG. 10 is a schematic block diagram of a terminal device according to an embodiment of this application.

FIG. 11 is a schematic block diagram of a terminal device according to an embodiment of this application.

FIG. 12 is a schematic block diagram of a network device according to an embodiment of this application.

FIG. 13 is a schematic block diagram of a network device according to an embodiment of this application.

FIG. 14 is a schematic diagram of startup timing of an RAR window according to an embodiment of this application.

FIG. 15 is a schematic flowchart of receiving a PDSCH transmission with repetitions by a UE according to an embodiment of this application.

FIG. 16 is a schematic diagram of an RV version in a PDSCH transmission with repetitions according to an embodiment of this application.

FIG. 17 is a schematic diagram showing that a part of a PDSCH transmission with repetitions occurs outside an RAR window according to an embodiment of this application.

FIG. 18 is a schematic diagram of a timing relationship subsequent to a repetition of a Msg2 PDSCH according to an embodiment of this application.

FIG. 19 is a schematic diagram of a timing relationship subsequent to a repetition of a Msg4 PDSCH according to an embodiment of this application.

FIG. 20 is a schematic block diagram of a communication device according to an embodiment of this application.

FIG. 21 is a schematic block diagram of a chip according to an embodiment of this application.

FIG. 22 is a schematic block diagram of a communication system according to an embodiment of this application.

### DESCRIPTION OF EMBODIMENTS

The following describes the technical solutions in embodiments of this application with reference to the accompanying drawings in embodiments of this application.

The technical solutions in embodiments of this application may be applied to various communication systems, such as a global system for mobile communications (GSM) system, a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolved NR system, an LTE-based access to unlicensed spectrum (LTE-U) system, an NR-based access to unlicensed spectrum (NR-U) system, a non-terrestrial networks (NTN) system, a universal mobile telecommunication system (UMTS) system, a wireless local area network (WLAN) system, a wireless fidelity (WiFi) system, a fifth generation communication (5G) system, or another communication system.

Generally, a quantity of connections supported by a conventional communication system is limited, and is easy to implement. However, with the development of communication technologies, a mobile communication system not only supports conventional communications, but also supports, for example, device to device (D2D) communication, machine to machine (M2M) communication, machine type communication (MTC), vehicle to vehicle (V2V) communication, or vehicle to everything (V2X) communication, and the like. Embodiments of this application can also be applied to these communication systems.

In one implementation, a communication system in embodiments of this application may be applied to a carrier aggregation (CA) scenario, a dual connectivity (DC) scenario, and a standalone (SA) networking scenario.

In one implementation, the communication system in embodiments of this application may be applied to an unlicensed spectrum, where the unlicensed spectrum may also be considered as a shared spectrum; or the communication system in embodiments of this application may be further applied to an authorized spectrum, where the authorized spectrum may also be considered as an unshared spectrum.

Various embodiments are described in this application with reference to a network device and a terminal device. The terminal device may also be referred to as a user equipment (UE), an access terminal, a user unit, a user station, a mobile station, a mobile console, a remote station, a remote terminal, a mobile device, a user terminal, a terminal, a wireless communication device, a user agent, a user apparatus, or the like.

The terminal device may be a station (ST) in a WLAN, a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communication system such as an NR network, a terminal device in a future evolved public land mobile network (PLMN) network, or the like.

In embodiments of this application, the terminal device can be deployed on land, including an indoor or outdoor scenario and a handheld or wearable or vehicle-mounted scenario, may be deployed on a water surface (such as a ship), or may be deployed in air (for example, on an aircraft, a balloon, and a satellite).

In embodiments of this application, the terminal device may be a mobile phone, a tablet computer (Pad), a computer with a wireless communication capability, a virtual reality (VR) terminal device, an augmented reality (AR) terminal device, a wireless terminal device in industrial control, a wireless terminal device in self driving, a wireless terminal device in remote medical application, a wireless terminal device in a smart grid, a wireless terminal device in transportation safety, a wireless terminal device in a smart city, a wireless terminal device in a smart home, or the like.

By way of example and without limitation, in embodiments of this application, the terminal device may be a wearable device. The wearable device may also be referred to as a wearable intelligent device, and is a general term for wearable devices, such as glasses, gloves, watches, clothes, and shoes, that are developed by applying wearable technologies to intelligent designs of daily wearables. The wearable device is a portable device that is directly worn on a body or integrated into clothes or an accessory of a user. The wearable device is not only a hardware device, but also implements powerful functions through software support, data interaction, and cloud interaction. In a broad sense, the wearable smart device may be a full-featured and large-size device that can implement some or all of functions without relying on a smart phone, for example a smart watch or smart glasses, or a device that focuses only on a specific type of application function and needs to be used together with another device such as a smart phones, for example, various types of smart bands and smart jewelry that monitor physical signs.

In embodiments of this application, the network device may be a device for communicating with a mobile device. The network device may be an access point (AP) in a WLAN, a base transceiver station (BTS) in a GSM or CDMA, a NodeB (NB) in WCDMA, an evolved NodeB (eNB, or eNodeB) in LTE, or a relay station or access point, or a vehicle-mounted device, a wearable device, a network device (gNB) in an NR network, a network device in a future evolved PLMN network, or a network device in an NTN network, or the like.

By way of example and without limitation, in embodiments of this application, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may alternatively be a base station arranged on land, water or the like.

In embodiments of this application, the network device may provide a service to a cell, and the terminal device communicates with the network device through a transmission resource (for example, frequency domain resource, or spectrum resource) used by the cell. The cell may be a cell corresponding to the network device (such as a base station), and the cell may belong to a macro base station or a base station corresponding to a small cell. The small cell herein may include: a metro cell, a micro cell, a pico cell, a femto cell, or the like. These small cells feature a small coverage range and low transmit power, and are suitable for providing high-speed data transmission services.

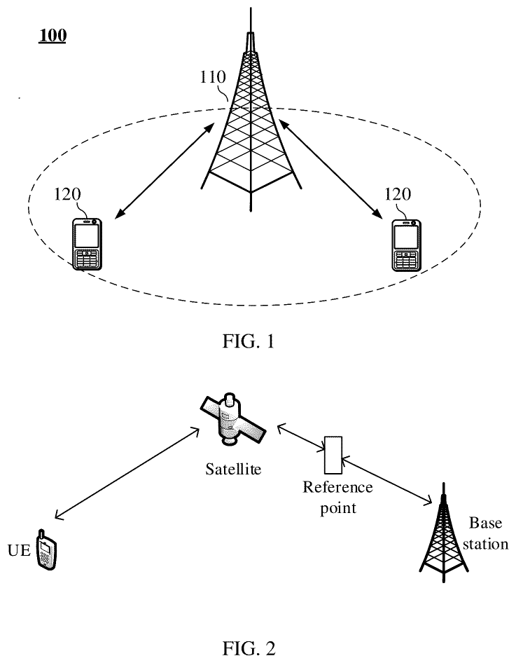

FIG. 1 exemplarily shows a communication system 100. The communication system includes a network device 110 and two terminal devices 120. In one implementation, the communication system 100 may include a plurality of network devices 110, and another quantity of terminal devices 120 may be included in the coverage of each network device 110, which is not limited in embodiments of this application.

In one implementation, the communication system 100 may further include other network entities such as a mobility management entity (MME) and an access and mobility management function (AMF), which is not limited in embodiments of this application.

The network device may further include an access network device and a core network device. That is, the wireless communication system further includes a plurality of core networks for communicating with the access network device. The access network device may be an evolved NodeB (eNB or e-NodeB for short), a macro base station, a micro base station (also referred to as a “small base station”), a pico base station, an access point (AP), a transmission point (TP), a new generation NodeB (gNodeB), or the like in a long-term evolution (LTE) system, a next-generation (mobile communication system) (next radio, NR) system, or an authorized auxiliary access long-term evolution (LAA-LTE) system.

It should be understood that a device with a communication function in a network/system in embodiments of this application may be referred to as a communication device. The communication system shown in FIG. 1 is used as an example. The communication device may include a network device and a terminal device with communication functions. The network device and the terminal device may be specific devices in embodiments of this application, and details are not described herein. The communication device may further include another device in the communication system, such as a network controller, a mobile management entity, and another network entity, which is not limited in embodiments of this application.

It should be understood that the terms “system” and “network” are often used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

It should be understood that, in embodiments of this application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In descriptions of embodiments of this application, the term “correspond” may mean that there is a direct or indirect correspondence between the two, or may mean that there is an association relationship between the two, or may mean that there is a relationship such as indicating and being indicated, or configuring and being configured.

For ease of understanding of the technical solutions of embodiments of this application, related technologies of embodiments of this application are described below. The following related technologies may be arbitrarily combined with the technical solutions of embodiments of this application as optional solutions, all of which belong to the protection scope of embodiments of this application.

### Random Access Response

### Startup of a Random Access Response (RAR) Window:

In response to physical random access channel (PRACH) transmission, a user equipment (UE) attempts to detect, within an RAR window controlled by a higher layer, downlink control information 1_0 (DCI 1_0) with cyclic redundancy check (CRC) scrambled by a random access radio network temporary identifier (RA-RNTI). The window is started at the 1^{st} symbol of an earliest control resource set (CORESET) in which a PDCCH configured for the UE for receiving a Type1-physical downlink control channel (PDCCH) common search space (CSS) set is located, that is, at least one symbol after the last symbol of a PRACH Occasion (RO) corresponding to the PRACH transmission. A length of the window is measured in slots, is determined based on a subcarrier spacing of the Type1-PDCCH CSS set, and is provided by a high-level parameter ra-Response Window.

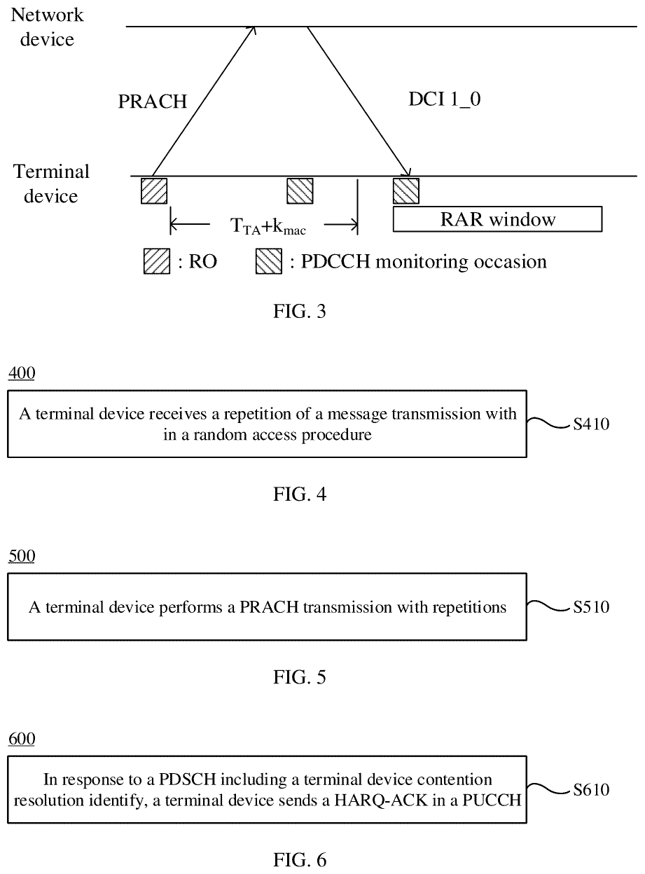

If N_{TA,adj}^{UE} or N_{TA,adj}^{common} is not equal to 0, that is, impact of a propagation delay of a non-terrestrial access network (NTN) system is considered, the RAR window is started after additional T_{TA}+k_{mac} ms (milliseconds). Herein, N_{TA,adj}^{UE} is a timing advance (TA) calculated by the UE based on a location of the UE and satellite ephemerides. N_{TA,adj}^{common} is a public TA configured based on a reference point and satellite ephemerides. T_{TA} is a total TA in consideration of N_{TA,adj}^{UE} and N_{TA,adj}^{common}·k_{mac} needs to cover a round-trip time (RTT) between the reference point and a base station, and can be provided by a high-level parameter K-Mac. It can be learned from FIG. 2 that T_{TA}+k_{mac} ms can cover a round-trip time between the base station and the UE in the NTN system, and startup timing of a corresponding RAR window is as shown in FIG. 3.

### RAR Message Received:

The UE passes a TB to a higher layer, if the UE successfully receives the RAR message, that is, within the RAR window: (1) DCI 1_0 with CRC scrambled by an RA-RNTI is detected; (2) the DCI 1_0 includes a least significant bit (LSB) field of a system frame number (SFN) of a system radio frame, and the LSB field is the same as an LSB of an SFN corresponding to a PRACH sent by the UE; and (3) the UE receives the transport block (TB) in a corresponding physical downlink shared channel (PDSCH). The higher layer parses the TB to obtain a random access preamble identity (RAPID) associated with the PRACH transmission. If the higher layer identifies the RAPID in the RAR message of the TB, the higher layer indicates an uplink grant to a physical layer, that is, a random access response RAR uplink grant of the physical layer.

Regarding a transmission slot of a physical uplink shared channel (PUSCH) scheduled by RAR uplink grant, if the UE receives a PDSCH carrying the RAR message in slot n, the UE sends the PUSCH in slot n+k₂+Δ+2μ·K_{cell,offet}, where values of k₂ and Δ are provided by an existing protocol, and K_{cell,offet} is provided by a high-level parameter for timing relationship enforcement in the NTN system.

The UE may assume that a minimum time interval between a last symbol of the PDSCH carrying the RAR message with the RAR uplink (UL) grant and the 1^{st} symbol of a PUSCH scheduled by the RAR UL grant is equal to N_{T,1}+N_{T,2}+0.5 ms. Herein, N_{T,1} is a time length of N₁ symbols corresponding to a PDSCH processing time, and N_{T,2} is a time length of N₂ symbols corresponding to a PUSCH preparation time.

### RAR Message not Received:

The higher layer may instruct the physical layer to send a PRACH, if the UE fails to successfully receive the RAR message, that is, in the RAR window: (1) DCI 1_0 with CRC scrambled by an RA-RNTI is not detected; (2) the DCI 1_0 includes an LSB field of an SFN, but the LSB field is different from an LSB of an SFN corresponding to a PRACH sent by the UE; (3) the UE fails to correctly receive a TB in the corresponding PDSCH; or (4) the higher layer fails to identify a RAPID associated with the PRACH transmission.

If the higher layer requests to send a PRACH, the UE expects to send the PRACH no later than N_{T,1}+0.75 ms after the last symbol of the RAR window or the last symbol of the PDSCH, where N_{T,1} is the time length corresponding to the PDSCH processing time.

### PDSCH Carrying a Contention Resolution Identifier

When the UE is not provided with a cell radio network temporary identity (Cell RNTI, C-RNTI), in response to transmission of a PUSCH scheduled by an RAR UL grant, the UE attempts to detect DCI 1_0 with a CRC scrambled by a temporary cell radio network temporary identity (Temporary Cell RNTI, TC-RNTI). The DCI1_0 schedules a PDSCH including a UE contention resolution identifier. In response to the PDSCH including the UE contention resolution indicator, the UE sends a hybrid automatic repeat request-acknowledgement (HARQ-ACK) in a physical uplink control channel (PUCCH). In addition, a minimum time between the last symbol of the PDSCH and the 1^{st} symbol of the PUCCH carrying the corresponding HARQ-ACK information is equal to N_{T,1}+0.75 ms.

### Repetition of PDSCH Transmission Solution

When the UE receives a PDSCH transmission scheduled by DCI 1_1 or 1_2 with CRC scrambled by a C-RNTI, a modulation coding scheme cell radio network temporary identifier (Modulation Coding Scheme Cell RNTI, MCS-C-RNTI), or a configured scheduling radio network temporary identifier (Configured Scheduling RNTI, CS-RNTI), if the UE is configured with a higher-level parameter pdsch-AggregationFactor=K, same symbol allocation is used in K consecutive slots. The UE expects repetition of a TB with same symbol allocation in each slot of the K consecutive slots, and the PDSCH is limited to a single transmission layer.

For example, a redundancy version (RV) of the n^{th} transmission occasion of the TB is determined based on Table 1, where n=0, 1, . . . , K−1.

TABLE 1
Applied RV when pdsch-AggregationFactor exists

| rv_{id} indicated | | | | |
|---|---|---|---|---|
| by DCI that | | | | |
| schedules the | Scaling factor | | | |
| PDSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Related technical solutions do not support a PDSCH transmission with repetitions in a random access procedure, such as Msg2 PDSCH and Msg4 PDSCH. For a communication scenario with limited coverage performance, such as the NTN system, a single PDSCH transmission may fail to meet a coverage requirement. Especially in an initial access phase, if an RAR message and a UE contention resolution identifier carried in a PDSCH cannot be successfully received, the UE cannot access a network, which greatly affects system performance. Therefore, PDSCH transmission in the random access procedure needs to be enhanced. For example, a solution of PDSCH transmission with repetition in a random access procedure is introduced, to improve coverage performance.

FIG. 4 is a schematic flowchart of a method of transmission with repetition 400 according to an embodiment of this application. The method may optionally be applied to the system shown in FIG. 1, but is not limited thereto. The method includes at least a part of the following content.

S410: A terminal device receives a repetition of a message transmission in a random access procedure.

In an example, messages in a four-step random access procedure may include: a PRACH (also referred to as message 1 or Msg1) sent by the terminal device to a network device, where the PRACH may include a preamble; a PDCCH and a PDSCH that includes an RAR message (also referred to as message 2 or Msg2) sent by the network device to the terminal device, where the PDSCH may be a PDSCH transmission scheduled by DCI with CRC scrambled by an RA-RNTI; a PUSCH (also referred to as message 3 or Msg3) sent by the terminal device to the network device; and a PDSCH and a PDCCH (also referred to as message 4 or Msg4) sent by the network device to the terminal device, where the PDSCH may be a PDSCH transmission scheduled by DCI with CRC scrambled by a TC-RNTI.

In an example, messages in a two-step random access procedure may include: a PRACH and a PUSCH (also referred to as message A, or MsgA) sent by the terminal device to the network device, where the PRACH may include a preamble; and a PDSCH and a PDCCH (also referred to as message B or MsgB) sent by the network device to the terminal device, where the PDSCH may be a PDSCH transmission scheduled by DCI with CRC scrambled by a MsgB-RNTI.

In this embodiment of this application, the terminal device may receive repetited transmission of one or more messages in a random access procedure. The terminal device may further repeatedly send or repeatedly transmit one or more messages in the random access procedure to the network device.

In this embodiment of this application, a repetition of a message transmission in a random access procedure can improve a success rate of random access.

In one implementation, that the terminal device receives a repetition of a message transmission in the random access procedure includes: the terminal device receives a PDSCH transmission with repetitions based on a number of repetitions of the PDSCH transmission.

For example, if the number of repetitions the PDSCH is 4, the terminal device receives four repetitions of the PDSCH from the network device.

In one implementation, a type of the PDSCH transmission includes at least one of the following:
a PDSCH transmission scheduled by DCI with CRC scrambled by a random access RA-RNTI; or
a PDSCH transmission scheduled by DCI with CRC scrambled by a TC-RNTI;
a PDSCH transmission scheduled by DCI with CRC scrambled by a MsgB-RNTI.

In one implementation, the method of transmission with repetition further includes: the terminal device requests a PDSCH transmission with repetitions. For example, after the terminal device requests the network device for the PDSCH transmission with repetitions, the network device repeatedly transmits the PDSCH to the terminal device. The terminal device receives the PDSCH transmission with repetitions from the network device.

In one implementation, that the terminal device requests a PDSCH transmission with repetitions includes at least one of the following:
the terminal device requests the PDSCH transmission with repetitions based on a specific PRACH format;
the terminal device requests the PDSCH transmission with repetitions based on a specific RO for sending a PRACH; or
the terminal device requests the PDSCH transmission with repetitions based on a specific PRACH preamble.

For example, if the terminal device uses a specific PRACH format to send a PRACH, after receiving the PRACH, the network device may determine that one or more PDSCHs in the random access procedure need to be repeatedly transmitted. For another example, if the terminal device sends a PRACH on a specific RO, after receiving the PRACH, the network device may determine that one or more PDSCHs in the random access procedure need to be repeatedly transmitted. For another example, if the terminal device sends a specific PRACH preamble, after receiving the PRACH preamble, the network device may determine that one or more PDSCHs in the random access procedure need to be repeatedly transmitted.

In one implementation, a manner of determining the number of repetitions of the PDSCH transmission includes one of the following:
the terminal device determines the number of repetitions of the PDSCH transmission based on system information broadcast by the network device;
in a case that the number of repetitions of the PDSCH transmission is not configured in the system information, the terminal device determines the number of repetitions of the PDSCH transmission based on a default value; or
the terminal device determines the number of repetitions of the PDSCH transmission based on N, where N is a positive integer.

In this embodiment of this application, one number of repetitions of a PDSCH may be broadcast in system information. After the terminal device requests the PDSCH transmission with repetitions, the received number of repetitions of the PDSCH transmission in the broadcast system information may be applied, to receive the PDSCH transmission with repetitions. If the terminal device requests the PDSCH transmission with repetitions, but the system information does not include the number of repetitions of the PDSCH transmission, the terminal device may receive the PDSCH transmission with repetitions based on a fixed value, that is, a default number of repetitions of the PDSCH transmission. The default number of repetitions of the PDSCH transmission may be a value specified in a protocol or preset. Alternatively, regardless of whether the system information is received, the terminal device may determine the number of repetitions of the PDSCH transmission based on a value N specified by the protocol or preset. For example, N may be 2, 4, 8, 16, or the like, and N may be specifically designed based on a coverage performance requirement. For example, if a difference between current PDSCH coverage performance and the coverage requirement is small, for example, is within 3 dB, N=2 can meet the coverage requirement. For another example, if a difference between current PDSCH coverage performance and the coverage requirement is large, for example, is 10 dB or above, N=16 is needed to meet the coverage requirement. The value N and the default number of repetitions of the PDSCH transmission may be the same or different.

In one implementation, a manner of determining the number of repetitions of the PDSCH transmission (which may be an implicit determining manner) includes one of the following:
the terminal device determines the number of repetitions of the PDSCH transmission based on a number of PRACH transmission repetitions or a number of PRACH sequence repetitions;
the terminal device determines, based on a number of repetitions of a PUSCH sent during the random access procedure, a number of repetitions of the PDSCH transmission scheduled by DCI with CRC scrambled by a TC-RNTI; or
the terminal device determines, based on a number of repetitions of the PDSCH transmission scheduled by DCI with CRC scrambled by an RA-RNTI, a number of repetitions of the PDSCH transmission scheduled by DCI with CRC scrambled by a TC-RNTI.

For example, the terminal device and/or the network device may determine, based on a number of repetitions of a PRACH (message 1 or message A) or a number of repetitions of a PRACH sequence sent by the terminal device, a number of repetitions of a PDSCH (message 2) scheduled by DCI with CRC scrambled by an RA-RNTI, a number of repetitions of a PDSCH (message 4) scheduled by DCI with CRC scrambled by a TC-RNTI, or a number of repetitions of a PDSCH (message B) scheduled by DCI with CRC scrambled by a MsgB-RNTI.

For another example, the terminal device and/or the network device may determine, based on a number of repetitions of a PUSCH (message 3) sent by the terminal device, a number of repetitions of a PDSCH (message 4) scheduled by DCI with CRC scrambled by a TC-RNTI.

For another example, the terminal device and/or the network device determines, based on a number of repetitions of the PDSCH transmission (message 2) scheduled by DCI with CRC scrambled by an RA-RNTI, a number of repetitions of the PDSCH transmission (message 4) scheduled by DCI with CRC scrambled by a TC-RNTI.

In one implementation, if the terminal device requests the PDSCH transmission with repetitions, but the number of repetitions of the PDSCH transmission is not included in the system information, the terminal device may alternatively determine the number of repetitions of the PDSCH transmission by using the foregoing implicit determining method.

In one implementation, a manner of determining the number of repetitions of the PDSCH transmission includes one of the following:
the terminal device determines the number of repetitions of the PDSCH transmission based on a set of candidate values for the number of repetitions of the PDSCH transmission in system information broadcast by a network device;
in a case that a set of candidate values for the number of repetitions of the PDSCH transmission is not configured in system information, the terminal device determines the number of repetitions of the PDSCH transmission based on a default set of candidate values for the number of repetitions of the PDSCH transmission; or
the terminal device determines the number of repetitions of the PDSCH transmission based on a set of M candidate values for the number of repetitions of the PDSCH transmission, where M is a positive integer.

In this embodiment of this application, if there are a plurality of candidate values in the set of candidate values for the number of repetitions of the PDSCH transmission, the DCI may be used to dynamically indicate a specific value of the number of repetitions of the PDSCH transmission. For example, a plurality of numbers of repetitions of the PDSCH may be broadcast in the system information, and the plurality of numbers of repetitions of the PDSCH form the set of candidate values for the number of repetitions of the PDSCH transmission. After the terminal device requests the PDSCH transmission with repetitions, the UE may apply the received set of numbers of repetitions of the PDSCH transmission in the broadcast system information, and determine one number of repetitions of the PDSCH transmission from the set of candidate values for the number of repetitions of the PDSCH transmission based on the DCI, to receive the PDSCH transmission with repetitions. If the terminal device requests the PDSCH transmission with repetitions, but there is no set of candidate values for the number of repetitions of PDSCH in the system information, the terminal device may use a set of fixed values, namely, a default set of candidate values for the number of repetitions of the PDSCH transmission, as the set of candidate values for the number of repetitions of the PDSCH transmission, and determine one number of repetitions of the PDSCH transmission from the set of candidate values for the number of repetitions of the PDSCH transmission based on the DCI, to receive the PDSCH transmission with repetitions. The default set of candidate values for the number of repetitions of the PDSCH transmission may be a set of numerical values specified in a protocol or preset.

Alternatively, regardless of whether the system information is received, the terminal device may determine the number of repetitions of the PDSCH transmission based on a set that includes M candidate values for the number of repetitions of the PDSCH transmission and that is specified by a protocol or preset. For example, M may be 4. For example, the set of candidate values may be {1, 2, 4, 8}. A number M of candidate values and a number of default values in the default value set may be the same or different.

In one implementation, the number of repetitions of the PDSCH transmission is indicated by an information field in DCI. In this embodiment of this application, an existing field of the DCI is reused as the information field, or a reserved bit of the DCI may be used to add a new information field.

In one implementation, the information field is a modulation coding scheme (MCS) field, and the MCS field is used to indicate an MCS corresponding to a scheduled PDSCH. In this embodiment of this application, the MCS field of the DCI may not only indicate an MCS corresponding to the scheduled PDSCH, but also indicate the number of repetitions of the PDSCH transmission. Reuse of the MCS field is merely an example rather than a limitation, and another field of the DCI may also be reused to indicate the number of repetitions of the PDSCH transmission.

In this embodiment of this application, some bits in the MCS field of the DCI indicate the number of repetitions of the PDSCH transmission, and some bits indicate the MCS corresponding to the PDSCH. In one implementation, a most significant bit (MSB) of the MCS field indicates the number of repetitions of the PDSCH transmission, and a least significant bit (LSB) of the MCS field indicates an MCS corresponding to the PDSCH. For example, a 2-bit MSB of the MCS field indicates the number of repetitions of the PDSCH transmission, and a 3-bit LSB of the MCS field indicates an MCS corresponding to the PDSCH.

In one implementation, a MSB of the MCS field indicates an MCS corresponding to the PDSCH, and an LSB of the MCS field indicates the number of repetitions of the PDSCH transmission. For example, a 3-bit MSB of the MCS field indicates an MCS corresponding to the PDSCH, and a 2-bit LSB of the MCS field indicates the number of repetitions of the PDSCH transmission.

In one implementation, the LSB of the MCS field indicates a used MCS index from a set of candidiate MCS indexes, or the MSB of the MCS field indicates a used MCS index from a set of candidiate MCS indexes; and the set of candidiate MCS indexes is configured by the network device through system information; or in a case that the set of candidiate MCS indexes is not configured, a default set is used as the set of candidiate MCS indexes.

In this embodiment of this application, because some bits of the MCS field are used to indicate the number of repetitions of the PDSCH transmission, the remaining bits of the MCS field can indicate less types of MCSs that correspond to the PDSCH. In this case, the set of candidiate MCS indexes may be configured in system information (for example, a high-layer parameter may be broadcast through a system information), and the set of candidiate MCS indexes includes a part, for example, eight MCS index candidate values. Signal quality is generally weak in a scenario requiring a PDSCH transmission with repetitions, and usually only MCS indexes with lower bit rates are used. Therefore, indicating a part of MCS index candidate values can also work normally. The terminal device may determine an MCS index from the set of candidiate MCS indexes based on an indication of the MCS field. In addition, if the set of candidiate MCS indexes is not configured in the system information, a set of fixed values, namely, a default set, may be used as the set of candidiate MCS indexes, and the terminal device may determine an MCS index from the default set based on the indication of the MCS field.

In one implementation, the information field includes a repetition number field, and the repetition number field is used to indicate the number of repetitions of the PDSCH transmission.

In this embodiment of the present disclosure, a reserved bit of the DCI may be used to add an information field, and the information field may include a repetition number field, or a field with another name.

In one implementation, the repetition number field occupies a reserved bit in the DCI.

In one implementation, the repetition number field occupies a reserved bit of a downlink allocation index (DAI) field of the DCI with CRC scrambled by a TC-RNTI.

In one implementation, the number of repetitions of the PDSCH transmission is K, and that the terminal device receives a PDSCH transmission with repetitions based on a number of repetitions of the PDSCH transmission includes:
the terminal device receives the PDSCH transmission with repetitions in K consecutive slots,
where the K consecutive slots and the PDSCH transmission have at least one of the following characteristics:
same symbol allocation is used for the PDSCH transmission in the K consecutive slots;
the terminal device repeatedly receives a TB from the PDSCH transmission with same symbol allocation in each slot of the K consecutive slots; or
the PDSCH transmission is performed on a single transmission layer.

In one implementation, a redundancy version corresponding to a 1^{st} transmission opportunity of repetitions of the PDSCH transmission is determined based on at least one of the following:
a default value of a redundancy version; or
an indication of a redundancy version field in the DCI.

In this embodiment of this application, a cyclic order of a redundancy version may be set, for example, [0 2 3 1]. Based on the cyclic order, the 1^{st} version number “0” may be used as a version number at the beginning of the cycle and as a default value of a redundancy version, and the cycle may be in the order of 0, 2, 3, and 1. The 1^{st} version number may alternatively be indicated by a redundancy version field of the DCI to be, for example, “2”, and the cycle may be in the order of 2, 3, 1, and 0.

FIG. 5 is a schematic flowchart of a method of transmission with repetition 500 according to another embodiment of this application. The method may optionally be applied to the system shown in FIG. 1, but is not limited thereto. The method includes at least a part of the following content.

S510: The terminal device performs a repetition of a PRACH transmission.

In this embodiment of this application, that the terminal device performs a repetition of a PRACH transmission may also be described as: the terminal device repeatedly transmits the PRACH, or the terminal device repeatedly sends the PRACH.

In one implementation, the method of transmission with repetition 500 may be combined with embodiments related to the foregoing method of transmission with repetition 400. For details, refer to the related description of the method 400. Details are not described herein again. For example, after the terminal device performs a repetition of a PRACH transmission to the network device, the terminal device receives a PDSCH transmission with repetitions based on the number of repetitions of the PDSCH transmission.

In one implementation, the method further includes: determining, by the terminal device, a random access response RAR window based on an RO corresponding to a last repetition of the PRACH transmission. For example, the terminal device starts a random access response (RAR) window based on an RO corresponding to a last repetition of the PRACH transmission. The terminal device may receive an RAR message in the RAR window.

In one implementation, determining a position of the RAR window includes at least one of the following:
determining, by the terminal device, a start position of the RAR window based on a symbol subsequent to a last symbol of the RO corresponding to the last repetition of the PRACH transmission; or
determining, by the terminal device, a start position of the RAR window based on a symbol subsequent to a last symbol of the RO corresponding to the last repetition of the PRACH transmission and a 1^{st} symbol of an earliest control resource set CORESET in which a PDCCH receiving a type 1 physical downlink control channel Type1-PDCCH common search space CSS set is located.

In one implementation, the terminal device starts the RAR window at at least one symbol subsequent to a last symbol of the RO corresponding to the last repetition of the PRACH transmission. For example, after repeatedly transmitting three PRACHs, the terminal device starts the RAR window at at least one symbol subsequent to a last symbol of an RO corresponding to the 3^{rd} repetition of the PRACH.

In one implementation, the terminal device starts the RAR window after at least one symbol subsequent to a last symbol of an RO corresponding to last repetition of the PRACH, and at the 1^{st} symbol of an earliest control resource set (CORESET) in which a PDCCH receiving a type 1 physical downlink control channel (Type1-PDCCH) common search space (CSS) set is located. For example, after repeatedly transmitting a PRACH three times, the terminal device starts the RAR window after at least one symbol subsequent to the last symbol of the RO corresponding to the last repetition of the PRACH transmission, and at the 1^{st} symbol of the earliest CORESET in which the PDCCH receiving the Type1-PDCCH CSS set is located.

In one implementation, the terminal device starts the RAR window after a delay following at least one symbol after the last symbol of the RO corresponding to the last repetition of the PRACH transmission, and at the 1^{st} symbol of the earliest CORESET in which the PDCCH receiving the Type1-PDCCH CSS set is located. The delay may represent a round-trip time between the terminal device and the network device. For example, the delay is equal to T_{TA}+k_{mac} ms, where N_{TA,adj}^{UE} is a timing advance (TA) calculated by the UE based on a location of the UE and satellite ephemerides, N_{TA,adj}^{common} is a public TA configured based on a reference point and satellite ephemerides, T_{TA} is a total TA in consideration of N_{TA,adj}^{UE} and N_{TA,adj}^{common} and k_{mac} needs to cover an RTT between the reference point and a base station. For example, the foregoing delay may be applied in a case that N_{TA,adj}^{UE} or N_{TA,adj}^{common} is not equal to 0, that is, in the case of an NTN system.

In this embodiment of this application, the requirement of “receiving an RAR message within the RAR window” can be lowered to “receiving DCI with CRC scrambled by an RA-RNTI within the RAR window”. For example, refer to the following description about successful reception of an RAR message in an RAR window and/or unsuccessful reception of an RAR message in an RAR window.

In one implementation, the successful reception of an RAR message within an RAR window includes at least one of the following:

DCI with CRC scrambled by an RA-RNTI is detected within the RAR window;
in a case that DCI with CRC scrambled by an RA-RNTI is detected within the RAR window, the DCI includes a least significant bit (LSB) field of a system radio frame SFN, and the LSB field in the DCI is the same as an LSB of an SFN corresponding to a PRACH sent by the terminal device;
in a case that DCI with CRC scrambled by an RA-RNTI is detected within the RAR window, the terminal device successfully receives a transport block TB in a PDSCH transmission scheduled by the DCI; or
a higher layer of the terminal device obtains a RAPID associated with PRACH transmission by passing a TB.

In one implementation, unsuccessful reception of an RAR message within an RAR window includes one of the following:
no DCI with CRC scrambled by an RA-RNTI is detected within the RAR window;
in a case that DCI with CRC scrambled by an RA-RNTI is detected within the RAR window, the DCI includes an LSB field of an SFN, but the LSB field in the DCI is different from an LSB of an SFN corresponding to a PRACH sent by the terminal device;
in a case that DCI with CRC scrambled by an RA-RNTI is detected within the RAR window, the terminal device fails to receive a TB in a PDSCH transmission scheduled by the DCI; or
a higher layer of the terminal device fails to identify a random access preamble identifier RAPID associated with PRACH transmission.

The higher layer and physical layer described above may be a higher layer and a physical layer in the terminal device.

In one implementation, a configurable maximum length of an RAR window is adjusted from a first length to a second length, where the second length is greater than the first length; and
that the terminal device receives a repetition of a message transmission in the random access procedure includes:
the terminal device receives an RAR message within an RAR window whose configurable maximum length is the second length.

In one implementation, a maximum length of the RAR window may be adjusted to be larger. For example, a maximum length of the RAR window is adjusted from a first length to a second length, where the second length is greater than the first length. For example, the maximum length of the RAR window is adjusted from 10 ms to 20 ms, 30 ms, 40 ms, or the like. A specific adjusted value may be set as required by an actual application scenario. The maximum length of the RAR window may be adjusted based on a protocol, a network configuration, a pre-configuration, or the like.

In one implementation, the method further includes: the terminal device determines a PUSCH transmission slot scheduled by an RAR uplink (UL) grant based on received last repetition of a PDSCH transmission carrying an RAR message. For example, the network device repeatedly transmits two PDSCHs carrying RAR messages to the terminal device, namely, PDSCH #1 and PDSCH #2. The terminal device may determine the PUSCH transmission slot scheduled by the RAR UL grant based on the received repetition of the 2^{nd} PDSCH, namely, PDSCH #2.

In one implementation, the PUSCH transmission slot is adjusted to a slot that is later, by a first duration, than a slot n at which a last repetition of the PDSCH transmission carrying the RAR message is received, where the first duration is determined based on a slot-level offset from the RAR UL grant to the PUSCH. For example, the first duration is equal to k₂+Δ+2^{μ}. K_{cell,offet}. Herein, values of k₂ and Δ may be provided by a relevant protocol, and K_{cell,offet} may be provided by a high-level parameter for timing relationship enforcement in the NTN system. The terminal device sends the PUSCH in slot n+k₂+Δ+2^{μ}·K_{cell,offet}.

In one implementation, a minimum time interval between a last symbol of a last repetition of a PDSCH transmission carrying an RAR message with an RAR uplink UL grant and a 1^{st} symbol of a PUSCH scheduled by the RAR UL grant is determined based on a PDSCH processing time and a PUSCH preparation time. For example, the minimum time interval is equal to N_{T,1}+N_{T,2}+0.5 ms. Herein, N_{T,1} is a time length of N₁ symbols corresponding to a PDSCH processing time, and N_{T,2} is a time length of N₂ symbols corresponding to a PUSCH preparation time.

In one implementation, the method further includes: in a case that the terminal device fails to receive an RAR message, and the higher layer instructs a physical layer to send a PRACH, expecting, by the terminal device, to send the PRACH no later than a second time duration after a last symbol of a last repetition of a PDSCH transmission, where the second time duration is determined based on the PDSCH processing time. For example, the second duration is equal to N_{T,1}+0.75 ms. Herein, N_{T,1} is a time length of N₁ symbols corresponding to the PDSCH processing time.

FIG. 6 is a schematic flowchart of a method of transmission with repetition 600 according to another embodiment of this application. The method may optionally be applied to the system shown in FIG. 1, but is not limited thereto. The method includes at least a part of the following content.

In one implementation, a transmission slot of a PUCCH is determined so that a minimum time interval between a last symbol of a last repetition of a PDSCH transmission and a 1^{st} symbol of a PUCCH carrying corresponding HARQ-ACK information is equal to a third duration, and the third duration is determined based on a PDSCH processing time. For example, the third duration is equal to N_{T,1}+0.75 ms. Herein, N_{T,1} is a time length of N₁ symbols corresponding to the PDSCH processing time.

In one implementation, in a case that the terminal device is not provided with a cell radio network temporary identifier (C-RNTI), the terminal device detects, in response to PUSCH transmission, DCI with CRC scrambled by a TC-RNTI, and receives a PDSCH transmission scheduled by DCI with CRC scrambled by a TC-RNTI.

In one implementation, the PDSCH transmission scheduled by DCI with CRC scrambled by a TC-RNTI is a PDSCH transmission including a terminal device contention resolution identify.

S610: In response to the PDSCH transmission including the terminal device contention resolution identify, the terminal device sends a HARQ-ACK in a PUCCH.

In this embodiment of this application, the PUSCH transmission may also be a repetition of a PUSCH transmission.

In one implementation, the method of transmission with repetition 600 may be combined with embodiments related to the foregoing method of transmission with repetition 400 and/or method of transmission with repetition 500. For details, refer to the related description of the method 400 and/or method of transmission with repetition 500. Details are not described herein again.

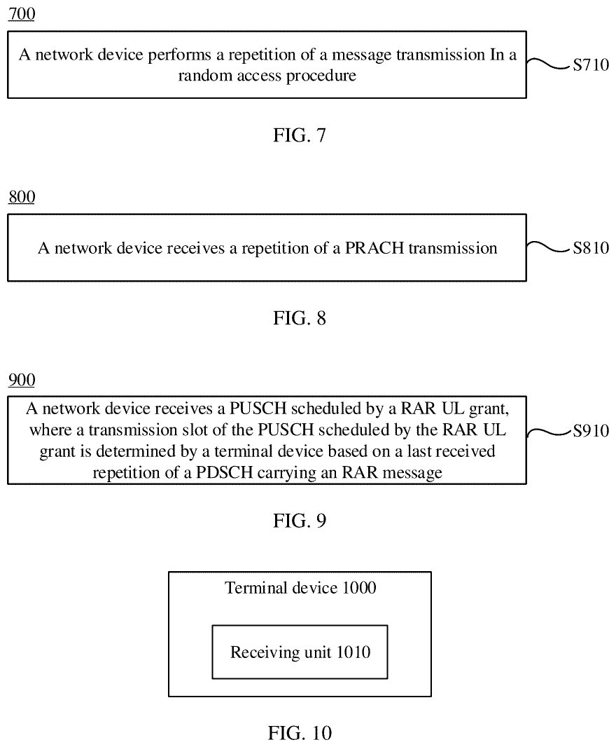

FIG. 7 is a schematic flowchart of a method of transmission with repetition 700 according to an embodiment of this application. The method may optionally be applied to the system shown in FIG. 1, but is not limited thereto. The method includes at least a part of the following content.

S710: A network device performs a repetition of a message transmission in a random access procedure.

In one implementation, that the network device performs a repetition of a message transmission in the random access procedure includes: the network device performs a PDSCH transmission with repetitions based on a number of repetitions of the PDSCH transmission.

In one implementation, a type of the PDSCH transmission includes at least one of the following:
a PDSCH transmission scheduled by downlink control information DCI with cyclic redundancy check CRC scrambled by a random access radio network temporary identifier RA-RNTI;
a PDSCH transmission scheduled by DCI with CRC scrambled by a temporary cell radio network temporary identifier TC-RNTI; or
a PDSCH transmission scheduled by DCI with CRC scrambled by a message B MsgB-RNTI.

In one implementation, the method further includes: the network device receives a request from a terminal device for the PDSCH transmission with repetitions.

In one implementation, that the network device receives a request from a terminal device for the PDSCH transmission with repetitions includes at least one of the following:
the network device receives the request from the terminal device for the PDSCH transmission with repetitions based on a specific PRACH format;
the network device receives the request from the terminal device for the PDSCH transmission with repetitions based on a specific RO for sending a PRACH; or
the network device receives the request from the terminal device for the PDSCH transmission with repetitions based on a specific PRACH preamble.

In one implementation, a manner of determining the number of repetitions of the PDSCH transmission includes one of the following:
broadcasting, by the network device, a number of repetitions of a PDSCH through system information;
in a case that the number of repetitions of the PDSCH transmission is not configured in system information, determining, by the network device, the number of repetitions of the PDSCH transmission based on a default value; or
determining the number of repetitions of the PDSCH transmission based on N, where N is a positive integer.

In one implementation, a manner of determining the number of repetitions of the PDSCH transmission includes one of the following:
determining, by the network device, the number of repetitions of the PDSCH transmission based on a number of PRACH transmission repetitions or a number of PRACH sequence repetitions that is sent by the terminal device;
determining, by the network device based on a number of repetitions of a PUSCH sent by the terminal device during the random access procedure, a number of repetitions of the PDSCH transmission scheduled by DCI with CRC scrambled by a TC-RNTI; or
determining, by the network device based on a number of repetitions of a PDSCH transmission scheduled by DCI with CRC scrambled by an RA-RNTI, a number of repetitions of the PDSCH transmission scheduled by DCI with CRC scrambled by a TC-RNTI.

In one implementation, a manner of determining the number of repetitions of the PDSCH transmission includes one of the following:
broadcasting, by the network device, a set of candidate values for the number of repetitions of the PDSCH transmission through system information;
in a case that a set of candidate values for the number of repetitions of the PDSCH transmission is not configured in system information, determining, by the network device, the number of repetitions of the PDSCH transmission based on a default set of candidate values for the number of repetitions of the PDSCH transmission; or
determining, by the network device, the number of repetitions of the PDSCH transmission based on a set of M candidate values for the number of repetitions of the PDSCH transmission, where M is a positive integer.

In one implementation, the number of repetitions of the PDSCH transmission is indicated by an information field in DCI.

In one implementation, the information field is an MCS field, and the MCS field is used to indicate an MCS corresponding to a scheduled PDSCH.

In one implementation, an MSB of the MCS field indicates the number of repetitions of the PDSCH transmission, and an LSB of the MCS field indicates an MCS corresponding to the PDSCH.

In one implementation, a MSB of the MCS field indicates an MCS corresponding to the PDSCH, and an LSB of the MCS field indicates the number of repetitions of the PDSCH transmission.

In one implementation, the LSB of the MCS field indicates a used MCS index from a set of candidiate MCS indexes, or the MSB of the MCS field indicates a used MCS index from a set of candidiate MCS indexes; and
the set of candidiate MCS indexes is configured by the network device through system information; or in a case that the set of candidiate MCS indexes is not configured, a default set is used as the set of candidiate MCS indexes.

In one implementation, the information field includes a repetition number field, and the repetition number field is used to indicate the number of repetitions of the PDSCH transmission. In one implementation, the repetition number field occupies a reserved bit in the DCI.

In one implementation, the repetition number field occupies a reserved bit of a downlink allocation index DAI field of the DCI with CRC scrambled by a TC-RNTI.

In this embodiment of this application, manners of determining the number of repetitions of the PDSCH transmission may be the same or different for the Msg2 PDSCH (PDSCH scheduled by DCI with CRC scrambled by an RA-RNTI), the Msg4 PDSCH (PDSCH scheduled by DCI with CRC scrambled by a TC-RNTI), and the MsgB PDSCH (PDSCH scheduled by DCI with CRC scrambled by a MsgB-RNTI). Specifically, any one or more of the foregoing manners of determining the number of repetitions of the PDSCH transmission in this embodiment of this application may be used based on an actual application scenario.

In one implementation, the number of repetitions of the PDSCH transmission is K, and that the network device performs a PDSCH transmission with repetitions based on a number of repetitions of the PDSCH transmission includes:
the network device performs the PDSCH transmission with repetitions in K consecutive slots,
where the K consecutive slots and the PDSCH transmission have at least one of the following characteristics:
same symbol allocation is used for the PDSCH transmission in the K consecutive slots;
a TB in the PDSCH transmission is repeatedly sent with same symbol allocation in each slot of the K consecutive slots; or
the PDSCH transmission is performed on a single transmission layer.

In one implementation, a redundancy version corresponding to a 1^{st} transmission opportunity of repetitions of the PDSCH transmission is determined based on at least one of the following:
a default value of a redundancy version; or
an indication of a redundancy version field in the DCI.

FIG. 8 is a schematic flowchart of a method of transmission with repetition 800 according to an embodiment of this application. The method may optionally be applied to the system shown in FIG. 1, but is not limited thereto. The method includes at least a part of the following content.

S810: A network device receives a repetition of a PRACH transmission.

In one implementation, the method of transmission with repetition 800 may be combined with embodiments related to the foregoing method of transmission with repetition 700. For details, refer to the related description of the method 700. Details are not described herein again. For example, after the network device receives a repetition of a PRACH transmission from the terminal device, the network device performs a PDSCH transmission with repetitions based on a number of repetitions of the PDSCH transmission.

In one implementation, that the network device performs a repetition of a message transmission in a random access procedure includes: the network device sends an RAR message based on a last repetition of a PRACH transmission.

In one implementation, a configurable maximum length of an RAR window is adjusted from a first length to a second length, where the second length is greater than the first length.

FIG. 9 is a schematic flowchart of a method of transmission with repetition 900 according to an embodiment of this application. The method may optionally be applied to the system shown in FIG. 1, but is not limited thereto. The method includes at least a part of the following content.

S910: A network device receives a PUSCH scheduled by an RAR UL grant, where a transmission slot of the PUSCH scheduled by the RAR UL grant is determined by a terminal device based on received last repetition of a PDSCH transmission carrying an RAR message.

In one implementation, the method of transmission with repetition 900 may be combined with embodiments related to the foregoing method of transmission with repetition 700 and/or method of transmission with repetition 800. For details, refer to the related description of the method 700 and/or method of transmission with repetition 800. Details are not described herein again.

In one implementation, the PUSCH transmission slot is adjusted to a slot that is later, by a first duration, than a slot at which a last repetition of the PDSCH transmission carrying the RAR message is received, where the first duration is determined based on a slot-level offset from the RAR UL grant to the PUSCH.

In one implementation, a minimum time interval between a last symbol of a last repetition of a PDSCH transmission carrying an RAR message with an RAR uplink UL grant and a 1^{st} symbol of a PUSCH scheduled by the RAR UL grant is determined based on a PDSCH processing time and a PUSCH preparation time.

In one implementation, that the network device receives a repetition of a PRACH transmission includes: the network device receives a PRACH sent in a case that the terminal device fails to receive an RAR message, where the terminal device expects to send the PRACH no later than a second time duration after a last symbol of a last repetition of the PDSCH transmission, where the second time duration is determined based on the PDSCH processing time.

In one implementation, the PDSCH transmission scheduled by DCI with CRC scrambled by a TC-RNTI is a PDSCH transmission including a terminal device contention resolution identify.

In one implementation, that the network device receives a PUSCH scheduled by an RAR UL grant includes: the network device receives a HARQ-ACK carried in a PUCCH.

In one implementation, a transmission slot of a PUCCH is determined so that a minimum time interval between a last symbol of a last repetition of a PDSCH transmission and a 1^{st} symbol of a PUCCH carrying corresponding HARQ-ACK information is equal to a third duration, and the third duration is determined based on a PDSCH processing time.

For specific examples in which the network device performs the methods 700, 800, and 900 in embodiments, refer to the related descriptions of the network device such as the base station in the foregoing methods 400, 500, and 600. For brevity, details are not described herein again.

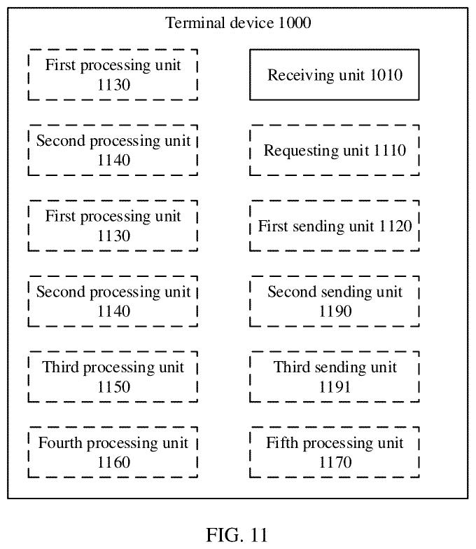

FIG. 10 is a schematic block diagram of a terminal device 1000 according to an embodiment of this application. The terminal device 1000 may include:
a receiving unit 1010, configured to receive a repetition of a message transmission in a random access procedure.

In one implementation, the receiving unit 1010 is further configured to receive a PDSCH transmission with repetitions based on a number of repetitions of the PDSCH transmission.

In one implementation, a type of the PDSCH transmission includes at least one of the following:
a PDSCH transmission scheduled by DCI with CRC scrambled by an RA-RNTI;
a PDSCH transmission scheduled by DCI with CRC scrambled by a TC-RNTI; or
a PDSCH transmission scheduled by DCI with CRC scrambled by a message B MsgB-RNTI.

In one implementation, as shown in FIG. 11, the terminal device further includes:
a requesting unit 1110, configured to request the PDSCH transmission with repetitions.

In one implementation, the requesting unit 1110 is configured to perform at least one of the following:
requesting the PDSCH transmission with repetitions based on a specific PRACH format;
requesting the PDSCH transmission with repetitions based on a specific RO for sending a PRACH; or
requesting the PDSCH transmission with repetitions based on a specific PRACH preamble.

In one implementation, the terminal device further includes a first processing unit 1130, and a manner of determining the number of repetitions of the PDSCH transmission by the first processing unit 1130 includes one of the following:
determining the number of repetitions of the PDSCH transmission based on system information broadcast by a network device;
in a case that the number of repetitions of the PDSCH transmission is not configured in system information, determining the number of repetitions of the PDSCH transmission based on a default value; or
determining the number of repetitions of the PDSCH transmission based on N, where N is a positive integer.

In one implementation, the terminal device further includes a second processing unit 1140, and a manner of determining the number of repetitions of the PDSCH transmission by the second processing unit 1140 includes one of the following:
determining the number of repetitions of the PDSCH transmission based on a number of PRACH transmission repetitions or a number of PRACH sequence repetitions;
determining, based on a number of repetitions of a PUSCH sent during the random access procedure, a number of repetitions of the PDSCH transmission scheduled by DCI with CRC scrambled by a TC-RNTI; or
determining, based on a number of repetitions of the PDSCH transmission scheduled by DCI with CRC scrambled by an RA-RNTI, a number of repetitions of the PDSCH transmission scheduled by DCI with CRC scrambled by a TC-RNTI.

In one implementation, the terminal device further includes a third processing unit 1150, and a manner of determining the number of repetitions of the PDSCH transmission by the third processing unit 1150 includes one of the following:
determining the number of repetitions of the PDSCH transmission based on a set of candidate values for the number of repetitions of the PDSCH transmission in system information broadcast by a network device;
in a case that a set of candidate values for the number of repetitions of the PDSCH transmission is not configured in system information, determining the number of repetitions of the PDSCH transmission based on a default set of candidate values for the number of repetitions of the PDSCH transmission; or
determining the number of repetitions of the PDSCH transmission based on a set of M candidate values for the number of repetitions of the PDSCH transmission, where M is a positive integer.

In one implementation, the number of repetitions of the PDSCH transmission is indicated by an information field in DCI.

In one implementation, the information field is an MCS field, and the MCS field is used to indicate an MCS corresponding to a scheduled PDSCH.

In one implementation, a most significant bit (MSB) of the MCS field indicates the number of repetitions of the PDSCH transmission, and an LSB of the MCS field indicates an MCS corresponding to the PDSCH.

In one implementation, a MSB of the MCS field indicates an MCS corresponding to the PDSCH, and an LSB of the MCS field indicates the number of repetitions of the PDSCH transmission.

In one implementation, the LSB of the MCS field indicates a used MCS index from a set of candidiate MCS indexes, or the MSB of the MCS field indicates a used MCS index from a set of candidiate MCS indexes; and
the set of candidiate MCS indexes is configured by the network device through system information; or in a case that the set of candidiate MCS indexes is not configured, a default set is used as the set of candidiate MCS indexes.

In one implementation, the information field includes a repetition number field, and the repetition number field is used to indicate the number of repetitions of the PDSCH transmission.

In one implementation, the repetition number field occupies a reserved bit in the DCI.

In one implementation, the repetition number field occupies a reserved bit of a downlink allocation index DAI field of the DCI with CRC scrambled by a TC-RNTI.

In one implementation, the number of repetitions of the PDSCH transmission is K, and that the terminal device receives a PDSCH transmission with repetitions based on a number of repetitions of the PDSCH transmission includes:
the terminal device receives the PDSCH transmission with repetitions in K consecutive slots,
where the K consecutive slots and the PDSCH transmission have at least one of the following characteristics:
same symbol allocation is used for the PDSCH transmission in the K consecutive slots;
the terminal device repeatedly receives a TB from the PDSCH transmission with same symbol allocation in each slot of the K consecutive slots; or
the PDSCH transmission is performed on a single transmission layer.

In one implementation, a redundancy version corresponding to a 1^{st} transmission opportunity of repetitions of the PDSCH transmission is determined based on at least one of the following:
a default value of a redundancy version; or
an indication of a redundancy version field in the DCI.

In one implementation, as shown in FIG. 11, the terminal device further includes:
a first sending unit 1120, configured to perform a repetition of a PRACH transmission.

In one implementation, as shown in FIG. 11, the terminal device further includes:
a fourth processing unit 1160, configured to determine an RAR window based on an RO corresponding to a last repetition of the PRACH transmission.

In one implementation, that the fourth processing unit 1160 determines a position of the RAR window includes at least one of the following:
determining a start position of the RAR window based on a symbol subsequent to a last symbol of the RO corresponding to the last repetition of the PRACH transmission; or
determining a start position of the RAR window based on a symbol subsequent to a last symbol of the RO corresponding to the last repetition of the PRACH transmission and a 1^{st} symbol of an earliest control resource set CORESET in which a PDCCH receiving a type 1 physical downlink control channel Type1-PDCCH common search space CSS set is located.

In one implementation, the symbol subsequent to the last symbol of the RO corresponding to the last repetition of the PRACH transmission may include at least one symbol subsequent to the last symbol of the RO corresponding to the last repetition of the PRACH transmission.

In one implementation, successful reception of an RAR message within an RAR window includes at least one of the following:
DCI with CRC scrambled by an RA-RNTI is detected within the RAR window;
in a case that DCI with CRC scrambled by an RA-RNTI is detected within the RAR window, the DCI includes a least significant bit LSB field of a system radio frame SFN, and the LSB field in the DCI is the same as an LSB of an SFN corresponding to a PRACH sent by the terminal device;
in a case that DCI with CRC scrambled by an RA-RNTI is detected within the RAR window, the terminal device successfully receives a transport block TB in a PDSCH transmission scheduled by the DCI; or
a higher layer of the terminal device obtains a RAPID associated with PRACH transmission by parsing a TB.

In one implementation, unsuccessful reception of an RAR message within an RAR window includes one of the following:
no DCI with CRC scrambled by an RA-RNTI is detected within the RAR window;
in a case that DCI with CRC scrambled by an RA-RNTI is detected within the RAR window, the DCI includes an LSB field of an SFN, but the LSB field in the DCI is different from an LSB of an SFN corresponding to a PRACH sent by the terminal device;
in a case that DCI with CRC scrambled by an RA-RNTI is detected within the RAR window, the terminal device fails to receive a TB in a PDSCH transmission scheduled by the DCI; or
a higher layer of the terminal device fails to identify a random access preamble identifier RAPID associated with PRACH transmission.

In one implementation, a configurable maximum length of an RAR window is adjusted from a first length to a second length, where the second length is greater than the first length; and the receiving unit is further configured to receive an RAR message within an RAR window whose configurable maximum length is the second length.

For example, a maximum length of the RAR window is adjusted from a first length to a second length, where the second length is greater than the first length.

In one implementation, as shown in FIG. 11, the terminal device further includes:
a fifth processing unit 1170, configured to determine a PUSCH transmission slot scheduled by an RAR uplink UL grant based on received last repetition of a PDSCH transmission carrying an RAR message.

In one implementation, the PUSCH transmission slot is adjusted to a slot that is later, by a first duration, than a slot at which the last repetition of the PDSCH transmission carrying the RAR message is received, where the first duration is determined based on a slot-level offset from the RAR UL grant to the PUSCH.

In one implementation, a minimum time interval between a last symbol of a last repetition of a PDSCH transmission carrying an RAR message with an RAR uplink UL grant and a 1^{st} symbol of a PUSCH scheduled by the RAR UL grant is determined based on a PDSCH processing time and a PUSCH preparation time.

In one implementation, as shown in FIG. 11, the terminal device further includes:
a second sending unit 1190, configured to: in a case that the terminal device fails to receive an RAR message, and the higher layer instructs a physical layer to send a PRACH, expect, by the terminal device, to send the PRACH no later than a second time duration after a last symbol of a last repetition of a PDSCH transmission, where the second time duration is determined based on the PDSCH processing time.

In one implementation, a PDSCH transmission scheduled by DCI with CRC scrambled by a TC-RNTI is a PDSCH transmission including a terminal device contention resolution identify, and as shown in FIG. 11, the terminal device further includes:
a third sending unit 1191, configured to: in response to the PDSCH transmission including the terminal device contention resolution identify, send a HARQ-ACK in a PUCCH,
where a transmission slot of the PUCCH is determined so that a minimum time interval between a last symbol of a last repetition of a PDSCH transmission and a 1^{st} symbol of the PUCCH carrying corresponding HARQ-ACK information is equal to a third duration, and the third duration is determined based on the PDSCH processing time.

The terminal device 1100 in this embodiment of this application can implement corresponding functions of the terminal device in the foregoing method embodiments. For processes, functions, implementations, and beneficial effects corresponding to each module (sub-module, unit, component, or the like) in the terminal device 1100, refer to the corresponding description in the foregoing method embodiments. Details are not described herein again. It should be noted that the described functions of various modules (sub-modules, units, components, or the like) in the terminal device 1100 in embodiments of this application may be implemented by different modules (sub-modules, units, components, or the like) or by a same module (sub-module, unit or component, or the like).

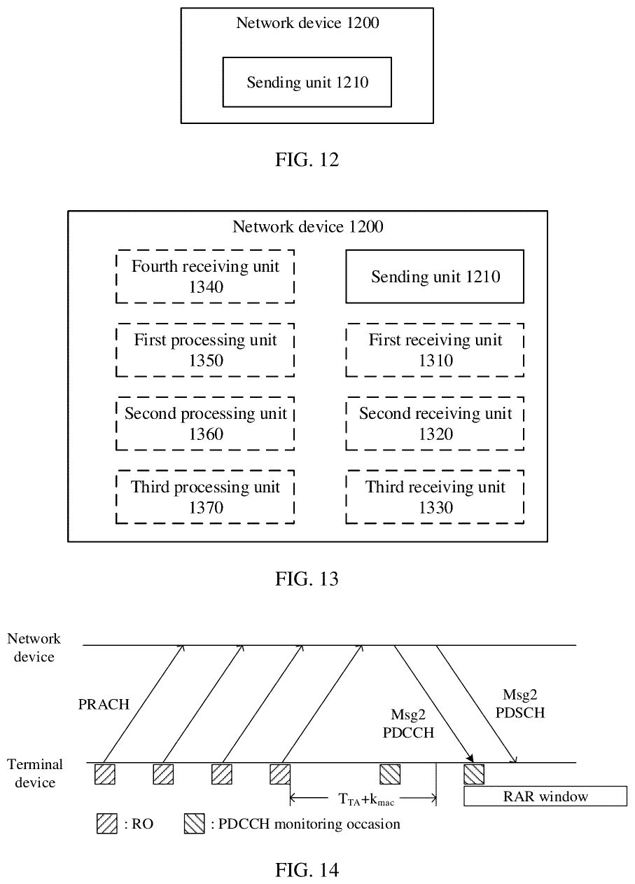

FIG. 12 is a schematic block diagram of a network device 1200 according to an embodiment of this application. The network device 1200 may include:
a sending unit 1210, configured to perform a repetition of a message transmission in a random access procedure.

In one implementation, the sending unit 1210 is further configured to perform a physical downlink shared channel PDSCH transmission with repetitions based on a number of repetitions of the PDSCH transmission.

In one implementation, a type of the PDSCH transmission includes at least one of the following:
a PDSCH transmission scheduled by downlink control information DCI with cyclic redundancy check CRC scrambled by a random access radio network temporary identifier RA-RNTI;
a PDSCH transmission scheduled by DCI with CRC scrambled by a temporary cell radio network temporary identifier TC-RNTI; or
a PDSCH transmission scheduled by DCI with CRC scrambled by a message B MsgB-RNTI.

In one implementation, as shown in FIG. 13, the network device further includes:
a first receiving unit 1310, configured to receive a request from a terminal device for the PDSCH transmission with repetitions.

In one implementation, the first receiving unit 1310 is further configured to perform at least one of the following:

receiving the request from the terminal device for the PDSCH transmission with repetitions based on a specific PRACH format;
receiving the request from the terminal device for the PDSCH transmission with repetitions based on a specific RO for sending a PRACH; or receiving the request from the terminal device for the PDSCH transmission with repetitions based on a specific PRACH preamble.

In one implementation, the network device further includes a first processing unit 1350, and a manner of determining the number of repetitions of the PDSCH transmission by the first processing unit 1350 includes one of the following:

broadcasting a number of repetitions of a PDSCH through system information;
in a case that the number of repetitions of the PDSCH transmission is not configured in system information, determining the number of repetitions of the PDSCH transmission based on a default value; or determining the number of repetitions of the PDSCH transmission based on N, where N is a positive integer.

In one implementation, the network device further includes a second processing unit 1360, and a manner of determining the number of repetitions of the PDSCH transmission by the second processing unit 1360 includes one of the following:
determining the number of repetitions of the PDSCH transmission based on a number of PRACH transmission repetitions or a number of PRACH sequence repetitions that is sent by the terminal device;
determining, based on a number of repetitions of a physical uplink shared channel PUSCH sent by the terminal device during the random access procedure, a number of repetitions of the PDSCH transmission scheduled by DCI with CRC scrambled by a TC-RNTI; or determining, based on a number of repetitions of the PDSCH transmission scheduled by DCI with CRC scrambled by an RA-RNTI, a number of repetitions of the PDSCH transmission scheduled by DCI with CRC scrambled by a TC-RNTI.

In one implementation, the network device further includes a third processing unit 1370, and a manner of determining the number of repetitions of the PDSCH transmission by the third processing unit 1370 includes one of the following:

broadcasting a set of candidate values for the number of repetitions of the PDSCH transmission through system information;
in a case that a set of candidate values for the number of repetitions of the PDSCH transmission is not configured in system information, determining the number of repetitions of the PDSCH transmission based on a default set of candidate values for the number of repetitions of the PDSCH transmission; or determining the number of repetitions of the PDSCH transmission based on a set of M candidate values for the number of repetitions of the PDSCH transmission, where M is a positive integer.

In one implementation, the number of repetitions of the PDSCH transmission is indicated by an information field in DCI.

In one implementation, the information field is an MCS field, and the MCS field is used to indicate an MCS corresponding to a scheduled PDSCH.

In one implementation, an MSB of the MCS field indicates the number of repetitions of the PDSCH transmission, and an LSB of the MCS field indicates an MCS corresponding to the PDSCH.

In one implementation, a MSB of the MCS field indicates an MCS corresponding to the PDSCH, and an LSB of the MCS field indicates the number of repetitions of the PDSCH transmission.

In one implementation, the LSB of the MCS field indicates a used MCS index from a set of candidiate MCS indexes, or the MSB of the MCS field indicates a used MCS index from a set of candidiate MCS indexes; and the set of candidiate MCS indexes is configured by the network device through system information; or in a case that the set of candidiate MCS indexes is not configured, a default set is used as the set of candidiate MCS indexes.

In one implementation, the information field includes a repetition number field, and the repetition number field is used to indicate the number of repetitions of the PDSCH transmission. In one implementation, the repetition number field occupies a reserved bit in the DCI.

In one implementation, the repetition number field occupies a reserved bit of a downlink allocation index DAI field of the DCI with CRC scrambled by a TC-RNTI.

In one implementation, the number of repetitions of the PDSCH transmission is K, and the sending unit is further configured to perform the PDSCH transmission with repetitions in K consecutive slots, where the K consecutive slots and the PDSCH transmission have at least one of the following characteristics:

same symbol allocation is used for the PDSCH transmission in the K consecutive slots;
a TB in the PDSCH transmission is repeatedly sent with same symbol allocation in each slot of the K consecutive slots; or
the PDSCH transmission is performed on a single transmission layer.

In one implementation, a redundancy version corresponding to a 1^{st} transmission opportunity of repetitions of the PDSCH transmission is determined based on at least one of the following:
a default value of a redundancy version; or an indication of a redundancy version field in the DCI.

In one implementation, as shown in FIG. 13, the network device further includes:
a second receiving unit 1320, configured to receive a repetition of a PRACH transmission.

In one implementation, the sending unit 1210 is configured to send an RAR message based on a last repetition of a PRACH transmission.

In one implementation, a configurable maximum length of an RAR window is adjusted from a first length to a second length, where the second length is greater than the first length.

In one implementation, as shown in FIG. 13, the network device further includes:
a third receiving unit 1330, configured to receive a PUSCH scheduled by an RAR UL grant, where a transmission slot of the PUSCH scheduled by the RAR UL grant is determined by the terminal device based on received last repetition of a PDSCH transmission carrying an RAR message.

In one implementation, the PUSCH transmission slot is adjusted to a slot that is later, by a first duration, than a slot at which the last repetition of the PDSCH transmission carrying the RAR message is received, where the first duration is determined based on a slot-level offset from the RAR UL grant to the PUSCH.

In one implementation, a minimum time interval between a last symbol of a last repetition of a PDSCH transmission carrying an RAR message with an RAR uplink UL grant and a 1^{st} symbol of a PUSCH scheduled by the RAR UL grant is determined based on a PDSCH processing time and a PUSCH preparation time.

In one implementation, the sending unit 1210 is configured to receive a PRACH sent in a case that the terminal device fails to receive an RAR message, where the terminal device expects to send the PRACH no later than a second time duration after a last symbol of a last repetition of a PDSCH transmission, where the second time duration is determined based on the PDSCH processing time.

In one implementation, a PDSCH transmission scheduled by DCI with CRC scrambled by a TC-RNTI is a PDSCH transmission including a terminal device contention resolution identify, and as shown in FIG. 13, the network device further includes:
a fourth receiving unit 1340, configured to receive a HARQ-ACK carried in a PUCCH;
where a transmission slot of the PUCCH is determined so that a minimum time interval between a last symbol of a last repetition of the PDSCH transmission and a 1^{st} symbol of the PUCCH carrying corresponding HARQ-ACK information is equal to a third duration, and the third duration is determined based on the PDSCH processing time.

The network device 1200 in this embodiment of this application can implement corresponding functions of the network device in the foregoing method embodiments. For processes, functions, implementations, and beneficial effects corresponding to each module (sub-module, unit, component, or the like) in the network device 1200, refer to the corresponding description in the foregoing method embodiments. Details are not described herein again. It should be noted that the described functions of various modules (sub-modules, units, components, or the like) in the network device 1200 in embodiments of this application may be implemented by different modules (sub-modules, units, components, or the like) or by a same module (sub-module, unit or component, or the like).

The method of transmission with repetition provided in embodiments of this application may include a solution of PDSCH transmission with repetition in a random access procedure. In this solution, manners of determining a number of repetitions of a PDSCH may include the following examples: (1) one number of repetitions of a PDSCH is broadcast through system information; (2) multiple numbers of repetitions of a PDSCH are broadcast through system information; (3) a protocol specifies a candidate value for a number of repetitions of a PDSCH; and (4) a number of repetitions of a PDSCH is implicitly determined. For indication of the number of repetitions of the PDSCH transmission in (2) and (3) above, an existing field in DCI may be reused, or a field for the number of repetitions of the PDSCH transmission may be introduced.

For reception of repetition of a Msg2 PDSCH, an RAR window may be started based on an RO corresponding to a last repetition of a PRACH transmission; and (1) DCI 1_0 with CRC scrambled by an RA-RNTI may be received within the RAR window, and (2) the RAR window length may be extended to receive the Msg2 PDSCH within the RAR window. In addition, transmission timing of a Msg3 PUSCH or a PRACH is determined based on last repetition of the Msg2 PDSCH.

For reception of repetition of a Msg4 PDSCH, transmission timing of a PUCCH may be determined based on last repetition of a Msg4 PDSCH.

### Example 1: Startup of an RAR Window

In a related technology, after a UE sends a PRACH, in response to the PRACH transmission, the UE attempts to detect, within an RAR window controlled by a higher layer, DCI 1_0 with CRC scrambled by an RA-RNTI, that is, Msg2 PDCCH. The DCI 1_0 schedules a Msg2 PDSCH carrying the RAR message.

For a scenario in which coverage enhancement is not required, the UE may select one RO to send the PRACH, and startup timing of the RAR window is consistent with that in a related technology.

For a scenario requiring coverage enhancement, such as an NTN system, if the UE chooses to perform a repetition of the PRACH on a plurality of ROs to improve coverage performance, the RAR window is configured by the UE to be started after at least one symbol subsequent to a last symbol of an RO corresponding to last repetition of the PRACH, and at a 1^{st} symbol of an earliest CORESET in which a PDCCH receiving a Type1-PDCCH CSS set is located. Similarly, in consideration of impact of a propagation delay in the NTN system, the RAR window needs to be started after additional T_{TA}+k_{mac} ms.

FIG. 14 is used as an example. In the NTN system, the UE performs repetitions of a PRACH transmission on four ROs. In this case, the UE is configured to start the RAR window, on a basis of additional delay from a last symbol of a last RO by T_{TA}+k_{mac} ms, at a 1^{st} symbol of an earliest CORESET in which a PDCCH configured for receiving a Type1-PDCCH CSS set is located.

### Example 2: Solution of PDSCH Transmission with Repetition in a Random Access Procedure

A solution of PDSCH transmission with repetition in a random access procedure is introduced, to improve coverage performance. Specific examples are as follows:

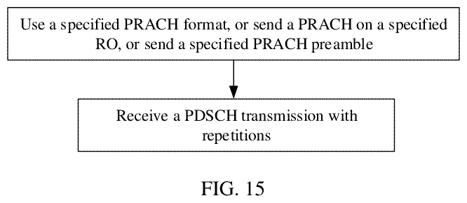

The UE may determine whether to request a base station to perform the PDSCH transmission with repetitions based on a current coverage situation and whether having a capability to receive the PDSCH transmission with repetitions. The UE may implicitly request the PDSCH transmission with repetitions through a specified random access resource. For example, as shown in FIG. 15, the UE uses a specified PRACH format, or sends a PRACH on a specified RO, or sends a specified PRACH preamble, to implicitly request the base station to perform the PDSCH transmission with repetitions. The UE may then receive the PDSCH transmission with repetitions.

For determining of the number K of repetitions of the PDSCH, there are the following design solutions:

### Solution 1: One Number of Repetitions of a PDSCH is Broadcast in System Information.

The system information is used to broadcast the number K of repetitions of a PDSCH. After the UE requests the PDSCH transmission with repetitions, the system information may be used to broadcast the number of repetitions of the PDSCH transmission. If the number of repetitions of the PDSCH transmission is not configured in the system information, a fixed value, such as 4, is provided as a default value of the broadcast number K of repetitions of the PDSCH.

### Solution 2: Multiple Numbers of Repetitions of a PDSCH is Broadcast in System Information

The system information is used to broadcast multiple numbers K={K₁, K₂, . . . } of repetitions of the PDSCH. After the UE requests the PDSCH transmission with repetitions, the system may be used to broadcast the set K={K₁, K₂, . . . } of candidate values for the number of repetitions of the PDSCH transmission. If the number of repetitions of the PDSCH transmission is not configured in the system information, a set of fixed numbers of repetitions of the PDSCH is provided, for example, a set K={K₁=1, K₂=2, K₃=3, K₄=4} is used as a broadcast default value set of the number of repetitions of the PDSCH transmission, as shown in Table 2.

TABLE 2
number of repetitions of PDSCH

| | Set of candidate values for the |
|---|---|
| Set of candidate values for the | number of repetitions of the |
| number of repetitions of the PDSCH | PDSCH transmission is not |
| transmission is configured | configured |
| 1^{st} value of the broadcast numbers of | 1 |
| repetitions of the PDSCH | |
| 2^{nd} value of the broadcast numbers of | 2 |
| repetitions of the PDSCH | |
| 3^{rd} value of the broadcast numbers of | 3 |
| repetitions of the PDSCH | |
| 4^{th} value of the broadcast numbers of | 4 |
| repetitions of the PDSCH | |

### Solution 3: A Protocol Specifies a Candidate Value for a Number of Repetitions of a PDSCH

The protocol specifies a group of candidate values for the number of repetitions of the PDSCH transmission, that is, a set {K₁, K₂, . . . } of candidate values for the number of repetitions of the PDSCH transmission, for example, {K₁=1, K₂=2, K₃=4, K₄=8}. After the UE requests the PDSCH transmission with repetitions, the introduced set {K₁, K₂, . . . } of candidate values for the number of repetitions of the PDSCH transmission can be applied.

### Solution 4: A Number of Repetitions of a PDSCH is Implicitly Determined

Numbers of repetitions of a Msg2 PDSCH and a Msg4 PDSCH are associated with a number of repetitions of another channel, thereby implicitly determining the number of repetitions of the PDSCH transmission. For example, transmission of the Msg2 PDSCH and the Msg4 PDSCH occurs after transmission of a PRACH, and if the number of repetitions of the PRACH sent by the UE or the number of PRACH sequence repetitions is N, the number K (K′) of repetitions of the Msg2 PDSCH (Msg4 PDSCH) may have a particular relationship with N, for example, K (K′)=N/P, where P is a scaling factor, for example P=2.

Similarly, transmission of the Msg4 PDSCH occurs after transmission of the Msg3 PUSCH, and if the number of repetitions of the Msg3 PUSCH is N, the number K of repetitions of the Msg4 PDSCH may have a particular relationship with N, for example, K=N/P, where P is a scaling factor, for example, P=2.

For Solution 2 and Solution 3, because multiple numbers of repetitions of a PDSCH are configured, it is necessary to further indicate a final applied value by using DCI 1_0. Considering that there is no field for indicating the number of repetitions of the PDSCH transmission in the current DCI 1_0, at least one of the following solutions may be used to indicate the number of repetitions of the PDSCH transmission:

(1) An existing field of the DCI 1_0 is reused, to indicate the number of repetitions of the PDSCH transmission. For example, a 5-bit MCS field of the DCI 1_0 may be reused, to indicate both an MCS corresponding to a PDSCH transmission scheduled by the DCI 1_0 and the number of repetitions of the PDSCH transmission.

For example, after the UE requests the PDSCH transmission with repetitions, the UE first determines candidate values for the number of repetitions of the PDSCH transmission, for example, {K₁=1, K₂=2, K₃=4, K₄=8}, and then further indicates the applied number of repetitions of the PDSCH transmission by using two most significant bits (MSBs) of the MCS field of the DCI 1_0. For example, 00 indicates the 1^{st} value K₁ of the set, 01 indicates the 2^{nd} value K₂ of the set, 10 indicates the 3^{rd} value of the set K₃, and 11 indicates the 4th value K₄ of the set, as shown in Table 3.

TABLE 3
Two MSBs of the MCS field of the DCI
1_0 indicating the number of repetitions

| Two MSBs of the MCS field | number of repetitions |
|---|---|
| 00 | 1 |
| 01 | 2 |
| 10 | 4 |
| 11 | 8 |

In addition, the UE determines the MCS corresponding to the PDSCH by using three least significant bits (LSBs) of the MCS field of the DCI 1_0. Considering that the original 5-bit MCS field can indicate MCS indexes 0 to 28 and three LSBs can indicate a maximum of eight MCS indexes, the base station needs to configure a set of candidate MCS indexes MCS={MCS1, . . . , MCS7} by using high-level parameters, and then three LSBs of the MCS field of the DCI 1_0 indicate a specific applied MCS index from the set of candidate MCS indexes MCS. It should be noted that if the set of candidate MCS indexes MCS is not configured, a fixed set of candidate MCS indexes, such as the set MCS'={MCS′₁=0, . . . , MCS′₇=7}, is provided as a default set of candidate MCS indexes, as shown in Table 4.

TABLE 4
Three LSBs of the MCS field of the
DCI 1_0 indicating an MCS index

| | | The set of |
|---|---|---|
| Three LSBs | | candidiate |
| of the MCS | The set of candidiate MCS indexes is | MCS indexes is |
| field | configured | not configured |
| 000 | 1^{st} value of the set of candidiate MCS | 0 |
| | indexes | |
| 001 | 2^{nd} value of the set of candidiate MCS | 1 |
| | indexes | |
| 010 | 3^{rd} value of the set of candidiate MCS | 2 |
| | indexes | |
| 011 | 4^{th} value of the set of candidiate MCS | 3 |
| | indexes | |
| 100 | 5^{th} value of the set of candidiate MCS | 4 |
| | indexes | |
| 101 | 6^{th} value of the set of candidiate MCS | 5 |
| | indexes | |
| 110 | 7^{th} value of the set of candidiate MCS | 6 |
| | indexes | |
| 111 | 8^{th} value of the set of candidiate MCS | 7 |
| | indexes | |

(2) A repetition number field is introduced into the DCI 1_0, to indicate the number of repetitions of the PDSCH transmission. DCI 1_0 with CRC scrambled by a TC-RNTI is used as an example. A downlink allocation index (DAI) field of the DCI 1_0 currently has two reserved bits, which may be used to introduce the repetition number field to indicate the number of repetitions of the PDSCH transmission. That is, if the UE requests the PDSCH transmission with repetitions, the DAI field has 0 bits, and the repetition number field has two bits to indicate the number of repetitions of the PDSCH transmission; if the UE does not request the PDSCH transmission with repetitions, the DAI field has still two reserved bits, and the repetition number field has 0 bits. Similarly, another reserved bit of DCI 1_0 with CRC scrambled by an RA-RNTI may also be used to introduce the repetition number field.

For example, after the UE requests the PDSCH transmission with repetitions, the UE first determines a set {K₁=1, K₂=2, K₃=4, K₄=8} for the number of repetitions based on Solution 2 or Solution 3, and then indicates an applied number of repetitions of the PDSCH transmission by using the repetition number field introduced in the DCI 1_0. For example, 00 indicates the 1^{st} value K₁ of the set, 01 indicates the 2^{nd} value K₂ of the set, 10 indicates the 3^{rd} value of the set K₃, and 11 indicates the 4th value K₄ of the set, as shown in Table 5.

### Table 5 Number of Repetitions of the PDSCH Transmission Corresponding to the Repetition Number Field

| Repetition | Number of repetitions of the |
|---|---|
| number field | PDSCH transmission |
| 00 | K₁ |
| 01 | K₂ |
| 10 | K₃ |
| 11 | K₄ |

Based on the foregoing solutions, the UE can determine the number K of repetitions of the PDSCH, to receive corresponding repetitions of the PDSCH transmission. Same symbol allocation is used for the PDSCH transmission in the K consecutive slots. The UE expects repetition of a TB with same symbol allocation in each slot of the K consecutive slots, and the PDSCH is limited to a single transmission layer.

For determining of a redundancy version, if an RV field does not exist in the DCI 1_0, for example, DCI 1_0 with CRC scrambled by an RA-RNTI, for a repetition of a PDSCH transmission scheduled by the DCI 1_0, such as the Msg2 PDSCH, a redundancy version rvid applied to an n^{th} transmission opportunity of the TB is determined based on the first row in Table 1, that is, rvid=0 for the 1^{st} transmission opportunity, and the redundancy version is periodically repeated based on [0 2 3 1], where n=0, 1, . . . , K−1.

If an RV field exists in the DCI 1_0, for example, DCI 1_0 with CRC scrambled by a TC-RNTI, for a repetition of a PDSCH transmission scheduled by the DCI 1_0, such as the Msg4 PDSCH, a redundancy version rvid applied to an n^{th} transmission opportunity of the TB is determined based on Table 1. In this case, the rvid of the 1^{st} transmission opportunity is indicated by the RV field of the DCI 1_0, and the redundancy version periodically repeated based on [0 2 3 1], where n=0, 1, . . . , K−1.

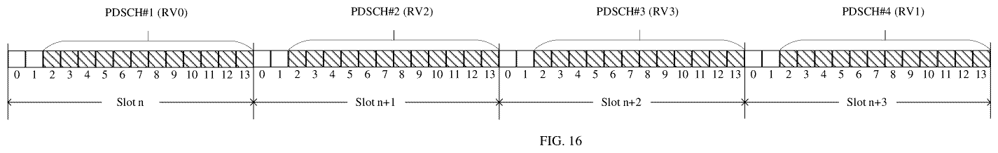

FIG. 16 is used as an example. The UE is scheduled by the DCI 1_0 with CRC scrambled by an RA-RNTI to perform PDSCH transmission in slot n, and the number K of repetitions is equal to 4. In this case, the UE performs repetitions of the PDSCH transmission in slot n to slot n+3, that is, four consecutive slots, and symbol allocation in each slot is the same, that is, the TB is repeated in symbols 2 to 13 in each slot. The rvid values of this TB at the four transmission occasions are 0, 2, 3, and 1 respectively.

### Example 3: PDSCH Processing Flow Introduced with Repetition of the PDSCH Transmission

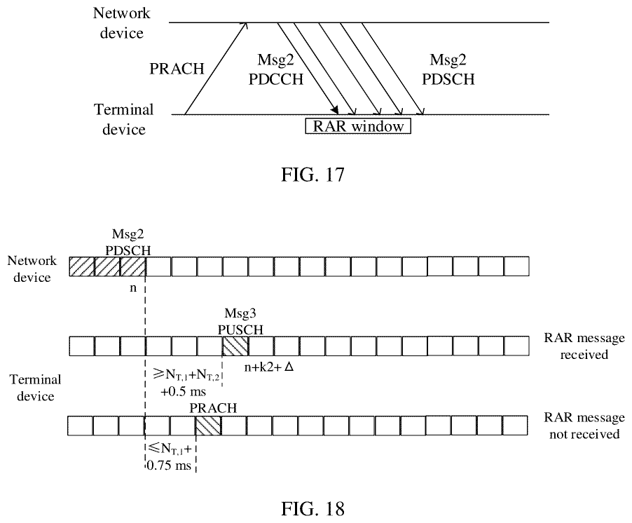

In the current random access procedure, the UE needs to complete reception of an RAR message within an RAR window. Considering that repetition of the Msg2 PDSCH increases a reception time of the RAR message, some transmission opportunities in PDSCH transmission with repetitions may occur outside the RAR window. Consequently, the UE may not be able to receive all repetitions of the PDSCH. For an example of some transmissions occurring outside the RAR window, refer to FIG. 17.

Therefore, it is necessary to enhance related behaviors of receiving RAR messages to ensure that the UE can receive all repetitions of the PDSCH. At least one of the following solutions can be used:

(1) The requirement of “receiving an RAR message within the RAR window” can be lowered to “receiving DCI 1_0 with CRC scrambled by an RA-RNTI within the RAR window”.

In this case, the UE passes a TB to a higher layer, if the UE successfully receives the RAR message, that is: (1) DCI 1_0 with CRC scrambled by an RA-RNTI is detected within the RAR window; (2) the DCI 1_0 includes a least significant bit (LSB) field of a system radio frame (SFN), and the LSB field is the same as an LSB of an SFN corresponding to a PRACH sent by the UE; and (3) the UE successfully receives the TB in the corresponding PDSCH.

The higher layer may instruct a physical layer to send a PRACH, if the UE fails to receive the RAR message, that is: (1) DCI 1_0 with CRC scrambled by an RA-RNTI is not detected within the RAR window; (2) the DCI 1_0 includes an LSB field of an SFN, but the LSB field is different from an LSB of an SFN corresponding to a PRACH sent by the UE; (3) the UE fails to receive a TB in the corresponding PDSCH; or (4) the higher layer fails to identify a RAPID associated with the PRACH transmission.

Because the UE is only required to receive the DCI 1_0 within the RAR window, even if a repetition of the Msg2 PDSCH occurs outside the RAR window, it can be ensured that the UE receives all repetitions of the PDSCH transmission.

(2) An RAR window length can be extended. Currently in a licensed frequency band, the RAR window length configured by a network is less than or equal to 10 ms. Therefore, the RAR window length can be extended, for example, a maximum RAR window length configured by a network can be extended to 40 ms to ensure that the UE receives all repetitions of the PDSCH within the RAR window.

After repetition of the Msg2 PDSCH is introduced, the following cases are included:

(1) If the RAR message is successfully received, a transmission slot of a PUSCH for RAR uplink grant scheduling is adjusted so that: if the UE receives, in slot n, a last repetition of a PDSCH transmission carrying the RAR message, the UE sends the PUSCH in slot n+k₂+Δ+2^{μ}·K_{cell,offet}. In addition, the UE may assume that a minimum time interval between a last symbol of a last repetition of the PDSCH transmission carrying the RAR message with the RAR UL grant and the 1^{st} symbol of a PUSCH scheduled by the RAR UL grant is equal to N_{T,1}+N_{T,2}+0.5 ms.

(2) If the RAR message is not successfully received and the higher layer instructs the physical layer to send a PRACH, the UE expects to send the PRACH no later than N_{T,1}+0.75 ms after the last symbol of a last repetition of the PDSCH transmission. For timing relationship subsequent to the repetition of the Msg2 PDSCH as shown in FIG. 18, K_{cell,offet}=0 can be assumed.

Subsequently, when the UE is not provided with a C-RNTI, in response to transmission of the Msg3 PUSCH, the UE attempts to detect DCI 1_0 with CRC scrambled by a TC-RNTI and receive a PDSCH including a UE contention resolution identifier and scheduled by the DCI 1_0, that is, the Msg4 PDSCH. In response to the PDSCH including the UE contention resolution identifier, the UE sends a HARQ-ACK in a PUCCH.

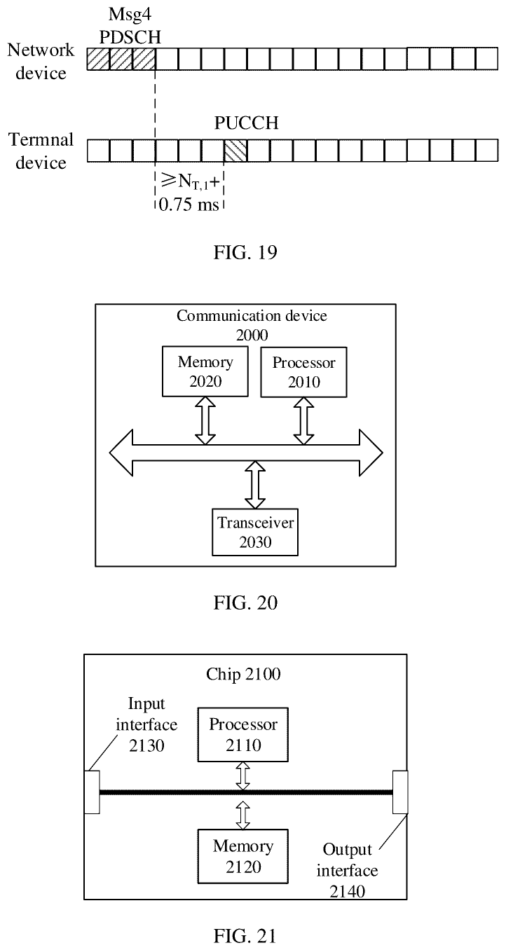

For a timing relationship subsequent to the repetition of the Msg4 PDSCH shown in FIG. 19, after the repetition of the Msg4 PDSCH is introduced, a transmission slot of the PUCCH is adjusted so that a minimum time between the last symbol of a last repetition of the PDSCH transmission and the 1^{st} symbol of a PUCCH carrying corresponding HARQ-ACK information is equal to N_{T,1}+0.75 ms.

According to the solution of PDSCH transmission with repetition in the random access procedure provided in this embodiment of this application, determining of the number of repetitions of the PDSCH transmission is as follows: (1) the number of repetitions of the PDSCH transmission is broadcast in system information, so that the number of repetitions of the PDSCH transmission can be flexibly configured. (2) A protocol introduces candidate values for the number of repetitions of the PDSCH transmission, which can achieve the PDSCH transmission with repetitions without increasing system information signaling overheads. (3) The number of repetitions of the PDSCH transmission is implicitly determined, without introducing additional signaling and processes for indicating the number of repetitions of the PDSCH transmission.

The number of repetitions of the PDSCH transmission is indicated as follows: (1) An existing field of the DCI can be reused without introducing a new field, which can reduce DCI signaling overheads. (2) Introduction of a TB scaling field can ensure that an indication function of the existing field is not affected.

A timing relationship of subsequent transmissions is determined based on a last repetition of the Msg2 PDSCH and the Msg4 PDSCH to ensure that the UE performs subsequent transmission after receiving all repetitions of the PDSCH.

The solutions in this embodiment of this application are designed based on the NTN system and the random access procedure, and can be extended to any system that applies PDSCH transmission with repetition.

FIG. 20 is a schematic diagram of a structure of a communication device 2000 according to an embodiment of this application. The communication device 2000 includes a processor 2010, and the processor 2010 can call and run a computer program from a memory so that the communication device 2000 implements the method in embodiments of this application.

In an implementation, the communication device 2000 may further include a memory 2020. The processor 2010 may invoke and run a computer program from the memory 2020 so that the communication device 2000 implements the method in embodiments of this application.

The memory 2020 may be independent of the processor 2010 or may be integrated into the processor 2010.

In one implementation, the communication device 2000 may further include a transceiver 2030, and the processor 2010 may control the transceiver 2030 to communicate with other devices, specifically, may send information or data to other devices, or receive information or data sent by other devices.

The transceiver 2030 may include a transmitting set and a receiving set. The transceiver 2030 may further include an antenna, and there may be one or more antennas.

In one implementation, the communication device 2000 may be the network device according to embodiments of this application, and the communication device 2000 may implement corresponding processes implemented by the network device in various methods according to embodiments of this application. For brevity, details are not described herein again.

In one implementation, the communication device 2000 may be the terminal device according to embodiments of this application, and the communication device 2000 may implement corresponding processes implemented by the terminal device in various methods according to embodiments of this application. For brevity, details are not described herein again.

FIG. 21 is a schematic structural diagram of a chip 2100 according to an embodiment of this application. The chip 2100 includes a processor 2110, and the processor 2110 may invoke a computer program from a memory and run the computer program to implement a method in embodiments of this application.

In one implementation, the chip 2100 may further include a memory 2120. The processor 2110 may invoke and run a computer program from the memory 2120 to implement the method performed by the terminal device or the network device in embodiments of this application.

The memory 2120 may be independent of the processor 2110 or may be integrated into the processor 2110.

In one implementation, the chip 2100 may further include an input interface 2130. The processor 2110 may control the input interface 2130 to communicate with another device or chip, and specifically, may obtain information or data transmitted by the another device or chip.

In one implementation, the chip 2100 may further include an output interface 2140. The processor 2110 may control the output interface 2140 to communicate with another device or chip, and specifically, may output information or data to the another device or chip.

In one implementation, the chip may be applied to the network device in embodiments of this application, and the chip may implement the corresponding processes implemented by the network device in various methods of embodiments of this application. For brevity, details are not described herein again.

In one implementation, the chip may be applied to the terminal device in embodiments of this application, and the chip may implement the corresponding processes implemented by the terminal device in the various methods in embodiments of this application. For brevity, details are not described herein again.

The chips used in the network device and the terminal device may be same or different chips.

It should be noted that the chip mentioned in embodiments of this application may also be referred to as a system-level chip, a system chip, a chip system, or a system-on-chip, or the like.

The processor mentioned above can be a general-purpose processor, a digital signal processor (DSP), a field programmable gate array (FPGA), an application specific integrated circuit (ASIC) or other programmable logic devices, transistor logic devices, discrete hardware components, etc. The general-purpose processor mentioned above may be a microprocessor, or may be any conventional processor or the like.

The memory mentioned above may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM).

It should be understood that, by way of example but not limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), a direct rambus random access memory (Direct Rambus RAM, DR RAM), or the like. In other words, the memory in embodiments of this application includes but is not limited to these memories and any memory of another proper type.

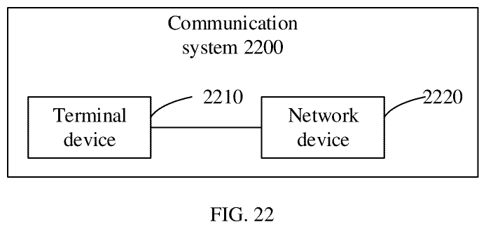

FIG. 22 is a schematic block diagram of a communication system 2200 according to an embodiment of this application. The communication system 2200 includes a terminal device 2210 and a network device 2220.

The terminal device 2210 is configured to receive a repetition of a message transmission in a random access procedure.

The network device 2220 is configured to perform a repetition of a message transmission in the random access procedure.

The terminal device 2210 may be configured to implement corresponding functions implemented by the terminal device in the foregoing methods, and the network device 2220 may be used to implement corresponding functions implemented by the network device in the foregoing methods. For brevity, details are not described herein again.

All or some of the foregoing embodiments may be implemented by using software, hardware, firmware, or any combination thereof. When software is used for implementation, embodiments may be implemented completely or partially in the form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state drive (SSD)), or the like.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A terminal device, comprising a processor configure to perform an operation of:
receiving a physical downlink shared channel (PDSCH) transmission with repetitions in a random access procedure, based on a number of repetitions of the PDSCH transmission,
wherein a type of the PDSCH transmission comprises at least one of following:
a PDSCH transmission scheduled by downlink control information (DCI) with cyclic redundancy check (CRC) scrambled by a random access radio network temporary identifier (RA-RNTI);
a PDSCH transmission scheduled by DCI with CRC scrambled by a temporary cell radio network temporary identifier (TC-RNTI); or
a PDSCH transmission scheduled by DCI with CRC scrambled by a MsgB-RNTI.

2. The terminal device according to claim 1, wherein the processor is configured to perform an operation of:
requesting the PDSCH transmission with repetitions.

3. The terminal device according to claim 2, wherein the processor is configured to perform an operation of:
requesting the PDSCH transmission with repetitions based on a specific physical random access channel (PRACH) format;
requesting the PDSCH transmission with repetitions based on a specific random access channel occasion (RO) for sending a PRACH; or
requesting the PDSCH transmission with repetitions based on a specific PRACH preamble.

4. The terminal device according to claim 1, wherein the processor is configured to perform an operation of:
determining the number of repetitions of the PDSCH transmission based on system information broadcast by a network device;
in a case that the number of repetitions of the PDSCH transmission is not configured in system information, determining the number of repetitions of the PDSCH transmission based on a default value; or
determining the number of repetitions of the PDSCH transmission based on N, wherein Nis a positive integer.

5. The terminal device according to claim 1, wherein the processor is configured to perform an operation of:
determining the number of repetitions of the PDSCH transmission based on a set of candidate values for the number of repetitions of the PDSCH transmission in system information broadcast by a network device;
in a case that a set of candidate values for the number of repetitions of the PDSCH transmission is not configured in system information, determining the number of repetitions of the PDSCH transmission based on a default set of candidate values for the number of repetitions of the PDSCH transmission; or
determining the number of repetitions of the PDSCH transmission based on a set of M candidate values for the number of repetitions of the PDSCH transmission, wherein M is a positive integer.

6. The terminal device according to claim 5, wherein the number of repetitions of the PDSCH transmission is indicated by an information field in DCI.

7. The terminal device according to claim 6, wherein the information field is an MCS field, and the MCS field is used to indicate an MCS corresponding to a scheduled PDSCH.

8. The terminal device according to claim 7, wherein a most significant bit (MSB) of the MCS field indicates the number of repetitions of the PDSCH transmission, and a least significant bit (LSB) of the MCS field indicates an MCS corresponding to the PDSCH; or an MSB of the MCS field indicates an MCS corresponding to the PDSCH, and an LSB of the MCS field indicates the number of repetitions of the PDSCH transmission,
wherein the LSB of the MCS field indicates a used MCS index from a set of candidiate MCS indexes, or the MSB of the MCS field indicates a used MCS index from a set of candidiate MCS indexes; and
the set of candidiate MCS indexes is configured by a network device in system information; or in a case that the set of candidiate MCS indexes is not configured, a default set is used as the set of candidiate MCS indexes.

9. The terminal device according to claim 6, wherein the information field comprises a repetition number field, and the repetition number field is used to indicate the number of repetitions of the PDSCH transmission.

10. The terminal device according to claim 1, wherein the number of repetitions of the PDSCH transmission is K, and the processor is configured to perform an operation of:
receiving the PDSCH transmission with repetitions in K consecutive slots,
wherein the K consecutive slots and the PDSCH transmission have at least one of following characteristics:
same symbol allocation is used for the PDSCH transmission in the K consecutive slots;
the terminal device repeatedly receives a TB from the PDSCH transmission with same symbol allocation in each slot of the K consecutive slots; or
the PDSCH transmission is performed on a single transmission layer.

11. The terminal device according to claim 1, wherein a redundancy version corresponding to a 1^{st} transmission opportunity of repetitions of the PDSCH transmission is determined based on at least one of following:
a default value of a redundancy version; or
an indication of a redundancy version field in the DCI.

12. The terminal device according to claim 1, wherein a PDSCH transmission scheduled by DCI with CRC scrambled by a TC-RNTI is a PDSCH transmission comprising a terminal device contention resolution identify, and the processor is configured to perform an operation of:
in response to the PDSCH transmission comprising the terminal device contention resolution identify, sending a HARQ-ACK in a PUCCH,
wherein a transmission slot of the PUCCH is determined so that a minimum time interval between a last symbol of a last repetition of the PDSCH transmission and a 1^{st} symbol of the PUCCH carrying corresponding HARQ-ACK information is equal to a third duration, and the third duration is determined based on the PDSCH processing time.

13. A network device, comprising a processor configured to perform an operation of:
performing a physical downlink shared channel (PDSCH) transmission with repetitions in a random access procedure based on a number of repetitions of the PDSCH transmission,
wherein a type of the PDSCH transmission comprises at least one of following:
a PDSCH transmission scheduled by downlink control information (DCI) with cyclic redundancy check (CRC) scrambled by a random access radio network temporary identifier (RA-RNTI);
a PDSCH transmission scheduled by DCI with CRC scrambled by a temporary cell radio network temporary identifier (TC-RNTI); or
a PDSCH transmission scheduled by DCI with CRC scrambled by a MsgB-RNTI.

14. The network device according to claim 13, wherein the processor is configured to perform an operation of:
receiving a request from a terminal device for the PDSCH transmission with repetitions.

15. The network device according to claim 14, wherein the processor is configured to perform an operation of:
receiving the request from the terminal device for the PDSCH transmission with repetitions based on a specific PRACH format;
receiving the request from the terminal device for the PDSCH transmission with repetitions based on a specific RO for sending a PRACH; or
receiving the request from the terminal device the PDSCH transmission with repetitions based on a specific PRACH preamble.

16. The network device according to claim 13, wherein the processor is configured to perform an operation of:
determining the number of repetitions of the PDSCH transmission based on a number of repetitions of a PDSCH in broadcast system information;
in a case that the number of repetitions of the PDSCH transmission is not configured in system information, determining the number of repetitions of the PDSCH transmission based on a default value; or
determining the number of repetitions of the PDSCH transmission based on N, wherein Nis a positive integer.

17. The network device according to claim 13, wherein the processor is configured to perform an operation of:
determining the number of repetitions of the PDSCH based on a set of candidate values for the number of repetitions of the PDSCH transmission in broadcast system information;
in a case that a set of candidate values for the number of repetitions of the PDSCH transmission is not configured in system information, determining the number of repetitions of the PDSCH transmission based on a default set of candidate values for the number of repetitions of the PDSCH transmission; or
determining the number of repetitions of the PDSCH transmission based on a set of M candidate values for the number of repetitions of the PDSCH transmission, wherein M is a positive integer.

18. The network device according to claim 13, wherein the number of repetitions of the PDSCH transmission is K, and the processor is configured to perform an operation of:
performing the PDSCH transmission with repetitions in K consecutive slots,
wherein the K consecutive slots and the PDSCH transmission have at least one of following characteristics:
same symbol allocation is used for the PDSCH transmission in the K consecutive slots;
a TB in the PDSCH transmission is repeatedly sent with same symbol allocation in each slot of the K consecutive slots; or
the PDSCH transmission is performed on a single transmission layer.

19. The network device according to claim 13, wherein a redundant version identifier corresponding to a 1^{st} transmission opportunity of repetitions of the PDSCH transmission is determined based on at least one of following:
a default value of a redundancy version; or
an indication of a redundancy version field in the DCI.

20. The network device according to claim 13, wherein a PDSCH transmission scheduled by DCI with CRC scrambled by a TC-RNTI is a PDSCH transmission comprising a terminal device contention resolution identify, and the processor is configured to perform an operation of:
receiving a HARQ-ACK carried in a PUCCH;
wherein a transmission slot of the PUCCH is determined so that a minimum time interval between a last symbol of a last repetition of the PDSCH transmission and a 1^{st} symbol of the PUCCH carrying corresponding HARQ-ACK information is equal to a third duration, and the third duration is determined based on the PDSCH processing time.
